(19) United States
(12) Patent Application Publication
(10) Pub. No.: US 2022/0400431 A1
(43) Pub. Date: Dec. 15, 2022

(54) ELECTRONIC DEVICE AND METHOD FOR WIRELESS COMMUNICATION, AND COMPUTER-READABLE STORAGE MEDIUM

(71) Applicant: Sony Group Corporation, Tokyo (JP)

(72) Inventors: Zhengyi ZHOU, Beijing (CN); Zhaocheng WANG, Beijing (CN); Ning GE, Beijing (CN); Jianfei CAO, Beijing (CN)

(73) Assignee: Sony Group Corporation, Tokyo (JP)

(21) Appl. No.: 17/797,118

(22) PCT Filed: Mar. 9, 2021
(86) PCT No.: PCT/CN2021/079616

§ 371 Date: Aug. 3, 2022

(30) Foreign Application Priority Data
Mar. 16, 2020 (CN) 202010181823.4

(51) Int. Cl. H04W 48/20; H04W 16/28

(52) U.S. Cl. CPC H04W 48/20; H04W 16/28

(57) ABSTRACT

Provided are an electronic device and a method for wireless communication, and a computer-readable storage medium. The electronic device for wireless communication comprises a processing circuit, wherein the processing circuit is configured to: when it is determined that the electronic device is an overload electronic device with the load thereof being greater than a predetermined threshold value, perform load balancing on the basis of a first beam power of a first beam which is scanned for the initial access of a user equipment and is received by a first user equipment from each adjacent electronic device of at least one adjacent electronic device of the overload electronic device, so as to determine whether the overload electronic device needs to be associated with the first user equipment.

### FIELD OF THE INVENTION

This application claims the priority of Chinese Patent Application No. 202010181823.4, entitled “ELECTRONIC DEVICE AND METHOD FOR WIRELESS COMMUNICATION, AND COMPUTER-READABLE STORAGE MEDIUM”, filed with the Chinese Patent Office on Mar. 16, 2020, the entire contents of which are incorporated herein by reference.

### TECHNICAL FIELD

The present disclosure relates to the technical field of wireless communications, particularly to user association and beam management in a multi-base station communication network, and more particularly, to an electronic device and method for wireless communications, and a computer-readable storage medium.

### BACKGROUND ART

A multi-base station communication network needs to consider User Association (UA) and Beam Management (BM). User association solves the problem concerning association between users and base stations, i.e., the problem concerning by which base station each user should be served; beam management solves the problem concerning which beam a base station should use to serve users associated therewith. In mobile communication systems prior to 5G, it is generally considered that there is only the problem of UA, but no problem of BM. However, in the era of 5G, UA and BM are coupled with each other; intuitively, BM should take place after UA, but actually, a BM's scheme will affect performance indices of the system, which thus will also in turn affect a UA's result.

In an actual system, there may be a case where the service capability of each base station is uneven; some base stations, such as macro base stations, have a higher transmit power or have been equipped with more antennas, and thus have stronger service capability; while some base stations, such as micro base stations, have relatively weak service capability. In this case, for example, a UA/BM scheme adopting the maximum receiving power criterion or the maximum signal-to-interference and noise ratio criterion will cause user equipments to tend to be associated with base stations with strong service capability, ultimately causing the base stations with strong service capability to be overloaded and base stations with weak service capability to be underloaded. FIG. 1 is a schematic diagram showing uneven network load resulting from uneven service capability of base stations in the prior art. As shown in FIG. 1, relatively more user equipments are associated with a base station with strong service capability, thus causing the base station with strong service capability to be overloaded, while relatively less user equipments are associated with a base station with weak service capability, thus causing the base station with weak service capability to be underloaded. This state in which the entire communication network is unevenly loaded will reduce system efficiency while bringing serious performance loss. However, the methods that can ensure the system performance in the prior art will increase the system overhead.

### SUMMARY OF THE INVENTION

A brief summary of the present invention is given below, to provide a basic understanding of some aspects of the present invention. It should be understood that the following summary is not an exhaustive summary of the present invention. It does not intend to determine a key or important part of the present invention, nor does it intend to limit the scope of the present invention. Its object is only to present some concepts in a simplified form, which serves as a preamble of a more detailed description to be discussed later.

According to one aspect of the present disclosure, there is provided an electronic device for wireless communications, comprising a processing circuit configured to: in a case of determining that the electronic device is an overloaded electronic device whose load is greater than a predetermined threshold, perform load balancing based on a first beam power of a first beam received by a first user equipment from each of at least one neighboring electronic device of the overloaded electronic device, to determine whether the overloaded electronic device is to be associated with the first user equipment, wherein the first beam is scanned for initial access of a user equipment.

The electronic device according to embodiments of the present disclosure can effectively improve the system performance used for user association and beam management in a multi-base station communication network and effectively reduce the system overhead.

According to another aspect of the present disclosure, there is provided an electronic device for wireless communications, comprising: a processing circuit configured to: in a case where a base station is an overloaded base station whose load is greater than a predetermined threshold, measure a beam power of a beam received from each of at least one neighboring base station of the overloaded base station, for the overloaded base station to perform load balancing, wherein the beam is scanned for initial access of the electronic device.

According to another aspect of the present disclosure, there is provided a method for wireless communications, comprising: in a case of determining that an electronic device is an overloaded electronic device whose load is greater than a predetermined threshold, performing load balancing based on a first beam power of a first beam received by a first user equipment from each of at least one neighboring electronic device of the overloaded electronic device, to determine whether the overloaded electronic device is to be associated with the first user equipment, wherein the first beam is scanned for initial access of the user equipment.

According to another aspect of the present disclosure, there is provided a method for wireless communications, comprising: in a case where a base station is an overloaded base station whose load is greater than a predetermined threshold, measuring a beam power of a beam received from each of at least one neighboring base station of the overloaded base station, for the overloaded base station to perform load balancing, wherein the beam is scanned for initial access of an electronic device.

According to other aspects of the present invention, there are further provided a computer program code and a computer program product for implementing the above-mentioned methods for wireless communications, as well as a computer-readable storage medium on which the computer program code for implementing the above-mentioned methods for wireless communications is recorded.

### BRIEF DESCRIPTION OF THE DRAWINGS

In order to further set forth the above and other advantages and features of the present invention, specific embodiments of the present invention will be further described in detail below in conjunction with the accompanying drawings. The accompanying drawings together with the following detailed description are included in this specification and form a part of this specification. Elements with identical functions and structures are denoted by identical reference numerals. It should be understood that, these figures only describe typical examples of the present invention, and should not be regarded as limitations to the scope of the present invention. In the accompanying drawings:

FIG. 1 is a block diagram showing uneven network load resulting from uneven service capability of base stations in the prior art;

FIG. 2 is a schematic diagram showing load allocation performed by a Cell Range Extension (CRE) method;

FIG. 3 is a schematic diagram showing load allocation performed based on a Global User Allocation (GUA) method;

FIG. 4 shows a block diagram of functional modules of an electronic device for wireless communications according to an embodiment of the present disclosure;

FIG. 5 shows exemplary information flow about offloading among an overloaded electronic device, a neighboring electronic device, a first user equipment, and a second user equipment according to an embodiment of the present disclosure;

FIG. 6 is an exemplary diagram showing performance of performing load balancing by the CRE method, the GUA method, and an offload strategy method according to an embodiment of the present disclosure;

FIG. 7 shows exemplary information flow about refusing access among the electronic device, the neighboring electronic device, and the first user equipment according to an embodiment of the present disclosure;

FIG. 8 shows a block diagram of functional modules of an electronic device according to another embodiment of the present disclosure;

FIG. 9 shows a flowchart of a method for wireless communications according to an embodiment of the present disclosure;

FIG. 10 shows a flowchart of a method for wireless communications according to another embodiment of the present disclosure;

FIG. 11 is a block diagram showing a first example of a schematic configuration of an eNB or gNB to which the technology of the present disclosure can be applied;

FIG. 12 is a block diagram showing a second example of a schematic configuration of an eNB or gNB to which the technology of the present disclosure can be applied;

FIG. 13 is a block diagram showing an example of a schematic configuration of a smart phone to which the technology of the present disclosure can be applied;

FIG. 14 is a block diagram showing an example of a schematic configuration of automobile navigation equipment to which the technology of the present disclosure can be applied;

FIG. 15 is a block diagram of an exemplary structure of a personal computer which can be adopted in the embodiments of the present disclosure.

### DETAILED DESCRIPTION OF THE EMBODIMENTS

Hereinafter, exemplary embodiments of the present disclosure will be described in conjunction with the accompanying drawings. For the sake of clarity and conciseness, the description does not describe all features of actual embodiments. However, it should be understood that in developing any such actual embodiment, many decisions specific to the embodiments must be made, so as to achieve specific objects of a developer; for example, those limitation conditions related to systems and services are satisfied, and these limitation conditions possibly will vary as embodiments are different. In addition, it should also be appreciated that, although developing work may be very complicated and time-consuming, such developing work is only routine tasks for those skilled in the art benefiting from the present disclosure.

It should also be noted herein that, to avoid the present disclosure from being obscured due to unnecessary details, only those apparatus structures and/or processing steps closely related to the solution according to the present disclosure are shown in the accompanying drawings, while omitting other details not closely related to the present disclosure.

As stated above, UA refers to by which base station each user should be served, i.e., determining users associated with a base station, in presence of a plurality of users; and BM refers to that a base station should select the most appropriate beam to serve users associated therewith.

For UA/BM, in the prior art, there are two kinds of relatively mainstream solutions. One is a method based on Cell Range Extension (CRE), and the other is a method based on Global User Allocation (GUA). The two methods are described below, respectively. For the convenience of description, a base station that tends to be overloaded because of relatively strong service capability is referred to as an O-TRP (Overloaded-Transmission-Reception-Point), and a base station that tends to be underloaded because of relatively weak service capability is referred to a U-TRP (Underloaded-Transmission-Reception-Point). Unless otherwise specified, the base station and the TRP may refer to each other.

The main idea of the CRE method is to add a forward bias value to an access index of U-TRP when comparing access indices of the O-TRP and the U-TRP for a user equipment, so that a user is more prone to select the U-TRP to initiate access than before implementing the CRE method. Taking the access criterion of maximum beam receiving power as an example, for the sake of convenience, a case where one O-TRP and J neighboring U-TRPs coexist which is relatively common in an actual system is considered here, where J is a positive integer greater than or equal to 1. Denoting a base station serial number of the O-TRP as 0, while denoting a receiving power of the k-th user in the network (hereinafter, the network is sometimes referred to as the system) with respect to the m-th beam of the O-TRP as P_{k,0}^{(m)} and a receiving power with respect to the n-th beam of the j (1≤j≤J)-th U-TRP as P_{k,j}⁽ⁿ⁾, then the CRE method may be expressed as:

$$( {j}^{*} , {b}^{*} ) = \{ \begin{matrix}( 0 , m ) , & if {P}_{k , 0}^{( m )} \geq {P}_{k , j}^{( n )} + {γ}_{CRE} \\ ( j , n ) , & if {P}_{k , 0}^{( m )} < {P}_{k , j}^{( n )} + {γ}_{CRE}\end{matrix} , \qquad ( Equation 1 )$$

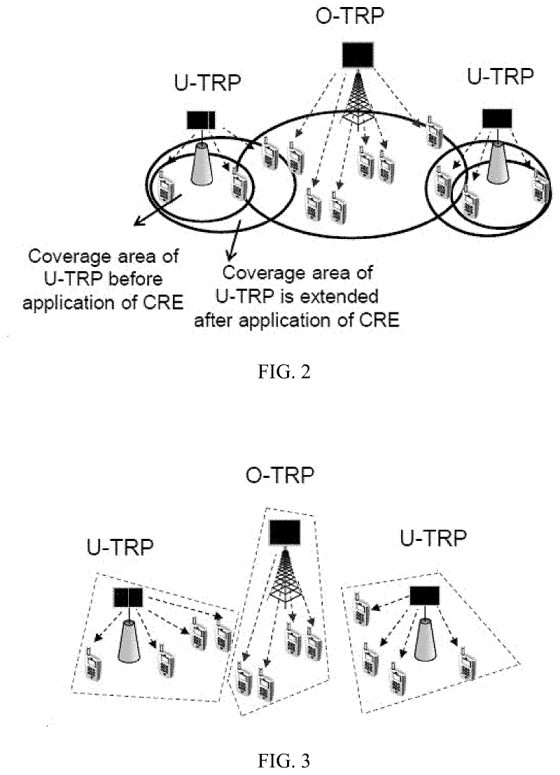

In Equation 1, j* and b* represent a serial number of a base station selected by the user equipment and a serial number of a corresponding beam, respectively, and γ_{CRE} (γ_{CRE}≥0is a bias value defined when the CRE method is used. It should be noted that, the selection of γ_{CRE} will influence the performance of the CRE method. If γ_{CRE} is set to a static constant value, a UA/BM result generated by the CRE method may be difficult to track real-time changes in a base station load situation; on the other hand, a dynamic setting manner is also relatively complicated in determining the bias value and implementing the system. Without loss of generality, taking a static setting of the bias value as an example, the result of the CRE method is as shown in FIG. 2. FIG. 2 is a schematic diagram showing load allocation performed by the CRE method. As shown in FIG. 2, by setting the bias value γ_{CRE}, the coverage area of U-TRP has been equivalently expanded, and some user equipments that would have chosen the O-TRP instead are associated with the U-TRP, thereby producing the effect of balancing the entire network load. However, it should be noted that, these user equipments having changed association results are often at the edge of the O-TRP and the U-TRP, and even if they are associated with the U-TRP, they are vulnerable to interference by the O-TRP, and the power received from the U-TRP is also relatively weak. Therefore, the CRE method makes relatively limited improvements to the system performance although it balances the network load.

The GUA method considers performing optimal division for all users in the system from a global perspective. Without loss of generality, the GUA method is described below based on the manner of maximizing the sum rate of the system.

It is assumed that there are K single-antenna user equipments and J+1 TRPs in total in the system, a serial number j=0 of a base station represents a O-TRP, a serial number 1 [symbol] j [symbol] J represents J U-TRPs, and each user can only be simultaneously served by one base station, where J is a positive integer greater than or equal to 1. A channel from a base station with a serial number j (0 [symbol] j [symbol] J) to the k-th user (1 [symbol] k [symbol] K) is denoted as h_{j,k}, a transmit power of a TRP with a serial number j (0 [symbol] j [symbol] J) is denoted as ρⱼ, a beamforming matrix as used is denoted as Wⱼ, and a corresponding set of associated user equipments is denoted as [symbol] ⱼ.

For the convenience of description, it is assumed that each base station adopts a beamforming method based on the Zero Forcing (ZF) criterion without loss of generality, a certain associated user equipment of the TRP with the serial number i-th (0 [symbol] i [symbol] J) is taken, it is assumed that a serial number of the user equipment is k, i.e., k∈ [symbol] ᵢ, and a rate of the user equipment may be expressed as:

$${R}_{k} = {log}_{2} ( 1 + \frac{\frac{{ρ}_{1}}{\vert {𝕂}_{i} \vert} {‖ {h}_{i , k}^{H} {W}_{i} ‖}^{2}}{{\sum }_{j \text{?} ρ j} {‖ {h}_{j , k}^{H} {W}_{j} ‖}^{2} + {σ}^{2}} ) \qquad ( Equation 2 )$$

$$\text{?} \text{indicates text missing or illegible when filed}$$

In Equation 2, σ² is a noise power at receiving end, and | [symbol] ᵢ| denotes the number of the user equipments in the set [symbol] .

Then the sum rate of the TRP with the serial number i-th (0 [symbol] i [symbol] J) may be expressed as:

$${C}_{i} = {\sum }_{k ∈ {𝕂}_{\text{?}}} {R}_{k} = {\sum }_{k ∈ {𝕂}_{\text{?}}} {log}_{2} ( 1 + \frac{\frac{{ρ}_{1}}{\vert {𝕂}_{i} \vert} {‖ {h}_{i , k}^{H} {W}_{i} ‖}^{2}}{{\sum }_{j \text{?} ρ j} {‖ {h}_{j , k}^{H} {W}_{j} ‖}^{2} + {σ}^{2}} ) \qquad ( Equation 3 )$$

$$\text{?} \text{indicates text missing or illegible when filed}$$

The sum rate of the entire system may be further expressed as:

$$C ( {𝕂}_{j} , {W}_{j} ) = {\sum }_{\text{?} = 0}^{J} {C}_{i} = {\sum }_{\text{?} = 0}^{J} {\sum }_{k ∈ {𝕂}_{\text{?}}} {log}_{2} ( 1 + \frac{\frac{{ρ}_{1}}{\vert {𝕂}_{i} \vert} {‖ {h}_{i , k}^{H} {W}_{i} ‖}^{2}}{{\sum }_{j \text{?} ρ j} {‖ {h}_{j , k}^{H} {W}_{j} ‖}^{2} + {σ}^{2}} ) \qquad ( Equation 4 )$$

$$\text{?} \text{indicates text missing or illegible when filed}$$

As can be seen from Equation 4, the magnitude of C( [symbol] ⱼ, Wⱼ) is influenced by the set [symbol] and the beamforming vector Wⱼ, or in other words, by the UA/BM result. Thus, based on such an index as the sum rate of the system, the GUA method may be expressed as:

(K*ⱼ,W*ⱼ)=arg max. [symbol] _{ⱼ}_{,w}_{ⱼ}C( [symbol] ⱼ,Wⱼ) (Equation 5)

Constraint conditions

∪ⱼ₌₀^{J} [symbol] ⱼ={1, . . . , K} (Constraint 1)

[symbol]

ⱼ_{₂}∩ [symbol] ⱼ_{₂}=∅ for ∀j₁≠j₂ (Constraint 2)

∥Wⱼ∥_{F}²=1 (Constraint 3)

In the above-mentioned constraint conditions, [symbol] denotes a collection, ∩ denotes an intersection, {1, . . . , K} denotes K user equipments, 1 [symbol] j₁ [symbol] J and 1 [symbol] j₂ [symbol] J.

That is to say, the GUA method attempts to find a UA/BM scheme, so that users can be optimally allocated to each base station, and meanwhile the base station will configure an optimal beam to serve its associated users. Note that in the above-mentioned optimization problem (i.e., constraint conditions), the constraint 1 and the constraint 2 about [symbol] ⱼ are to require the allocation for the users to be “without repetition and omission”, and the constraint 3 about Wⱼ is derived from a transmit power constraint of the base station. FIG. 3 is a schematic diagram showing load allocation performed by the GUA method. As shown in FIG. 3, a load associated with each base station is relatively uniform.

However, it is not difficult to see from the modeling process of the GUA method that the solution of the GUA method is more complicated and has high calculation complexity. On the other hand, when the sum rate of the system is calculated, a large amount of Channel State Information (CSI) (i.e., h_{j,k} in Equation 4) is required to be mastered. That is, the GUA method requires CSI from each base station to each user in the system, and acquiring CSI of such a scale will bring huge measurement and feedback overhead. More importantly, acquiring accurate CSI requires the base station to configure a CSI-Reference Signal (CSI-RS) for users completing initial access, which means that when the GUA method is actually applied, it is required to first use a traditional method to obtain a preliminary result of UA/BM, then acquire CSI from each base station to each user on this basis, and thereafter use the GUA method to re-optimize the preliminary result, to ultimately achieve an optimal UA/BM scheme so as to improve the system performance. The huge calculation complexity and CSI acquisition overhead turn to the most predominant factors restricting the application of GUA methods.

As can be seen from the above description, the CRE method is relatively simple and easy to implement, but makes limited improvements to the system performance; and the GUA method makes obvious improvements to the system performance, but involves huge calculation complexity and system overhead.

With regard to the above problems in the prior art, the present application proposes a new scheme to realize UA/BM.

Embodiments according to the present disclosure are described in detail below in conjunction with the accompanying drawings.

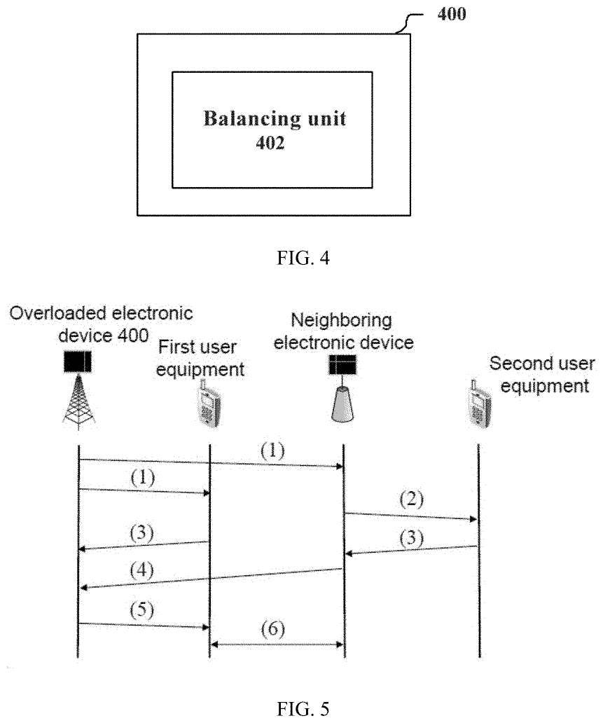

FIG. 4 shows a block diagram of functional modules of an electronic device 400 for wireless communications according to an embodiment of the present disclosure. As shown in FIG. 4, the electronic device 400 comprises a balancing unit 402, which may be configured to: in a case of determining that the electronic device 400 is an overloaded electronic device whose load is greater than a predetermined threshold, perform load balancing based on a first beam power of a first beam received by a first user equipment from each of at least one neighboring electronic device of the overloaded electronic device, to determine whether the overloaded electronic device is to be associated with the first user equipment, wherein the first beam is scanned for initial access of a user equipment.

Wherein the balancing unit 402 may be implemented by one or more processing circuitries which may be implemented as, for example, a chip.

The electronic device 400 may be arranged on base station side or communicably connected to a base station, for example. It should also be noted herein that, the electronic device 400 may be implemented at chip level or at device level. For example, the electronic device 400 may work as a base station itself, and may also include external devices such as a memory, a transceiver (not shown) and the like. The memory may be used to store programs and related data information that the base station needs to execute in order to implement various functions. The transceiver may include one or more communication interfaces to support communication with different devices (e.g., a user equipment, other base stations, etc.), and the implementation form of the transceiver is not specifically limited here.

As an example, a load is a user equipment associated with an electronic device. As an example, the balancing unit 402 may be configured to determine whether the electronic device is an overloaded electronic device according to the number of user equipments associated with the electronic device. That is, the balancing unit 402 may be configured to determine whether the electronic device is an overloaded electronic device according to the number of user equipments within a service range of the electronic device. As an example, the balancing unit 402 may be configured to determine that the electronic device is an overloaded electronic device in a case where the number of user equipments associated with the electronic device is greater than a predetermined threshold, and to determine that the electronic device is an underloaded electronic device in a case where the number of user equipments associated with the electronic device is less than or equal to the predetermined threshold. As an example, the electronic device may transition between two states, i.e., overloaded and underloaded, according to the number of user equipments with which it is currently associated.

As an example, the predetermined threshold may be set according to actual needs, experience, and performance of electronic devices, etc.

As an example, in addition to being based on the load, the balancing unit 402 may determine whether the electronic device 400 is an overloaded electronic device further according to the capability (e.g., antennas, transmit power and the like of the electronic device) of the electronic device 400.

As an example, in addition to being based on the load, the balancing unit 402 may determine whether the electronic device 400 is an overloaded electronic device further according to resources (e.g., spectrums and the like of the electronic device) of the electronic device 400.

Hereinafter, the case where the electronic device 400 is an overloaded electronic device is mainly discussed. For the convenience of description, the electronic device 400 is sometimes referred to as the overload electronic device 400.

As an example, the overloaded electronic device 400 may be an apparatus with relatively strong service capability, for example, may be a macro base station in a heterogeneous network.

As an example, the neighboring electronic device may comprise an underloaded electronic device whose load is less than or equal to the predetermined threshold, and the underloaded electronic device may be, for example, a micro base station in a heterogeneous network. In a local heterogeneous network, a coverage range of a micro base station is generally included in a coverage range of a neighboring macro base station. As an example, the neighboring electronic device may also be other overloaded electronic devices.

As an example, the neighboring electronic device of the overloaded electronic device 400 (e.g., macro base station) may comprise at least one of: all electronic device covered within the coverage range of the overloaded electronic device 400; at least one other electronic device within a predetermined range from the overloaded electronic device 400; all electronic device covered within the coverage range of the above-mentioned at least one other electronic device.

As an example, the balancing unit 402 may be configured to interact with each neighboring electronic device for load information. As an example, the overloaded electronic device 400 and the neighboring electronic device maintain related information such as each other's load state and the like in the form of a load situation table.

The load situation table may be established according to the way as shown in Table 1 below:

TABLE 1

| | Number | |
|---|---|---|
| | of currently | |
| Base station | associated user | |
| serial numbers | equipments | Load states |
| Base station 0 | K₀ | overloaded |
| Base station 1 | K1 | underloaded |
| . . . | . . . | . . . |
| Base station j | Kⱼ | overloaded |
| Base station J | K_{J} | overloaded |

In Table 1, the number of base stations in the system is J+1, and Kⱼ (0 [symbol] j [symbol] J) represents the number of user equipments currently associated with a base station with a serial number j, where J is a positive integer greater than or equal to 1. In a case where Kⱼ is greater than the above-mentioned predetermined threshold, it is determined that the base station with the serial number j is in an overloaded state, and in case where Kⱼ is less than or equal to the above-mentioned predetermined threshold, it is determined that the base station with the serial number j is in an underloaded state.

Determining whether the overloaded electronic device is to be associated with the first user equipment refers to determining, for example, whether the overloaded electronic device serves the first user equipment. The load balancing is used for performing user association UA and beam management BM.

In the actual system, UA/BM may be considered to be performed and maintained by steps such as Initial Access (IA), Beam Refinement (BR) and the like. In order to support initial access of a new user equipment, each base station will periodically perform beam scanning, that is, the base station will broadcast a synchronization signal with each beam in turn according to a predetermined beam codebook (to reduce the overhead, a wide beam is generally used at this time, the beam configured by the base station in this phase is usually referred to as an access beam). In an initial access phase, a user equipment will measure a beam power of a beam from a neighboring base station adjacent thereto, wherein the beam is scanned for initial access of the user equipment. Those skilled in the art can understand that both user equipments within the service range of the base station and user equipments not within the service range of the base station can measure the beam power of the access beam of the base station.

In an embodiment according to the present disclosure, the electronic device 400 performs load balancing based on a beam power (for differentiation from beam powers received by other user equipments from other electronic devices hereinafter, the beam power is referred to as a first beam power) of an access beam received by a first user equipment from each neighboring electronic device, so as to perform user association and beam management.

The base station with the serial number i=0 (hereinafter referred to as the current base station) in the GUA method described above may be equivalent to the electronic device 400 in the embodiment of the present disclosure, and the user equipment associated with the base station with i=0 may be equivalent to the first user equipment in the embodiment of the present disclosure.

Equation 4 in the GUA method described above may be written in the following form:

$$C ( {𝕂}_{j} , {W}_{j} ) = {\sum }_{k ∈ {𝕂}_{\text{?}}} {log}_{2} ( 1 + \frac{\frac{{ρ}_{0}}{\vert {𝕂}_{0} \vert} {‖ {h}_{0 , k}^{H} {W}_{0} ‖}^{2}}{{\sum }_{j \text{?} ρ j} {‖ {h}_{j , k}^{H} {W}_{j} ‖}^{2} + {σ}^{2}} ) + {\sum }_{\text{?}}^{J} {\sum }_{k ∈ {𝕂}_{\text{?}}} {log}_{2} ( 1 + \frac{\frac{{ρ}_{1}}{\vert {𝕂}_{i} \vert} {\vert {h}_{i , k}^{H} {W}_{i} \vert}^{2}}{{\sum }_{j \text{?} ρ j} {\vert {h}_{j , k}^{H} {W}_{j} \vert}^{2} + {σ}^{2}} ) \qquad ( Equation 5 )$$

$$\text{?} \text{indicates text missing or illegible when filed}$$

In Equation 5,

$${\sum }_{k ∈ {𝕂}_{\text{?}}} {log}_{2} ( 1 + \frac{\frac{{ρ}_{0}}{\vert {𝕂}_{0} \vert} {‖ {h}_{0 , \text{?}}^{H} {W}_{0} ‖}^{2}}{{\sum }_{j \text{?} ρ j} {‖ {h}_{j , k}^{H} {W}_{j} ‖}^{2} + {σ}^{2}} )$$

$$\text{?} \text{indicates text missing or illegible when filed}$$

represents the sum rate of the current base station, and

$${\sum }_{k ∈ {𝕂}_{\text{?}}} {log}_{2} ( 1 + \frac{\frac{{ρ}_{1}}{\vert {𝕂}_{i} \vert} {\vert {h}_{i , k}^{H} {W}_{i} \vert}^{2}}{{\sum }_{j \text{?} ρ j} {\vert {h}_{j , k}^{H} {W}_{j} \vert}^{2} + {σ}^{2}} )$$

$$\text{?} \text{indicates text missing or illegible when filed}$$

represents the sum rate of the base station with the serial number i (1 [symbol] i [symbol] J).

In the GUA method, h_{0,k} (k∈ [symbol] ₀) in Equation 5 is the CSI between the current base station with the serial number 0 and the k-th user equipment associated therewith, and can be obtained by configuring CSI-RS measurements; h_{j,k} (j≠0, k∈ [symbol] ₀) in

$${\sum }_{k ∈ {𝕂}_{\text{?}}} {log}_{2} ( 1 + \frac{\frac{{ρ}_{0}}{\vert {𝕂}_{0} \vert} {‖ {h}_{0 , \text{?}}^{H} {W}_{0} ‖}^{2}}{{\sum }_{j \text{?} ρ j} {‖ {h}_{j , k}^{H} {W}_{j} ‖}^{2} + {σ}^{2}} )$$

$$\text{?} \text{indicates text missing or illegible when filed}$$

in Equation 5 is the CSI between the k-th user equipment associated with the current base station with the serial number 0 and the base station with the serial number j that is not associated with the user equipment, which cannot be obtained through direct measurements, and thus acquiring h_{j,k} is the main source of the system overhead.

However, in the electronic device 400 according to the embodiment of the present disclosure, the load balancing is performed through the first beam power obtained by measuring the access beam of the neighboring electronic device by the first user equipment, without requiring to additionally configure a reference signal (i.e., without requiring additional overhead) to obtain channel state information between each neighboring electronic device and the first user equipment, and thus the system overhead can be saved, and thereby user association and beam management in a multi-base station communication network can be effectively implemented.

As an example, the first user equipment is a user equipment associated with the overloaded electronic device, and the balancing unit 402 may be configured to perform the load balancing further based on a second beam power of a second beam received by a second user equipment associated with each neighboring electronic device from an electronic device that is not associated with the second user equipment among the overloaded electronic device and the at least one neighboring electronic device, wherein the second beam is scanned for initial access of the user equipment.

As an example, that the first user equipment is a user equipment associated with the overloaded electronic device refers to that the first user equipment is within the service range of the overloaded electronic device and is a user equipment that has been served by the overloaded electronic device. The second user equipment associated with each neighboring electronic device refers to that the second user equipment is within the service range of the neighboring electronic device and is a user equipment that has been served by the neighboring electronic device.

The J base stations represented by the serial number 1 [symbol] i [symbol] J in the GUA method described above may be equivalent to the at least one neighboring electronic device adjacent to the electronic device 400 in the embodiment of the present disclosure, and the user equipments that are respectively associated with the above-mentioned J base stations may be equivalent to the second user equipment associated with the neighboring electronic device in the embodiment of the present disclosure. In the GUA method, in

$${\sum }_{\text{?}}^{J} {\sum }_{k ∈ {𝕂}_{\text{?}}} {log}_{2} ( 1 + \frac{\frac{{ρ}_{1}}{\vert {𝕂}_{i} \vert} {\vert {h}_{i , k}^{H} {W}_{i} \vert}^{2}}{{\sum }_{j \text{?} ρ j} {\vert {h}_{j , k}^{H} {W}_{j} \vert}^{2} + {σ}^{2}} )$$

$$\text{?} \text{indicates text missing or illegible when filed}$$

in Equation 5, h_{i,k} (1 [symbol] i [symbol] J, k∈ [symbol] ᵢ) is the CSI between the base station with the serial number i and the k-th user equipment associated therewith, which can be obtained by configuring CSI-RS measurements; h_{j,k} (1 [symbol] i [symbol] J, j≠i, k∈ [symbol] ᵢ) is the CSI between the k-th user equipment associated with the base station with the serial number i and the base station with the serial number j that is not associated with the user equipment, which cannot be obtained through direct measurements, and thus acquiring h_{j,k} is the main source of the system overhead.

However, in the electronic device 400 according to the embodiment of the present disclosure, the load balancing is performed through the second beam power of the access beam received by the second user equipment associated with each neighboring electronic device from the electronic device that is not associated with the second user equipment, without requiring additional overhead to obtain channel state information between the electronic device that is not associated with the second user equipment and the second user equipment, and thus the system overhead can be further saved, and thereby user association and beam management in a multi-base station communication network can be effectively implemented.

As an example, the balancing unit 402 may be configured to offload at least part of user equipments associated with the overloaded electronic device from the overloaded electronic device based on the first beam power corresponding to the overloaded electronic device and the second beam power corresponding to each neighboring electronic device.

As an example, offloading at least part of user equipments associated with the overloaded electronic device from the overloaded electronic device refers to that the overloaded electronic device ceases to serve the at least part of user equipments.

In an initial access phase, each base station will perform scanning with multiple beams, that is, the overloaded electronic device 400 and the neighboring electronic device will perform scanning with multiple beams, respectively.

As an example, the first beam power is a weighted mean of a beam receiving power of each first beam, and the second beam power is a weighted mean of a beam receiving power of a second beam corresponding to each neighboring electronic device. In addition to the weighted mean, those skilled in the art can also think of other ways of association between the first beam power and the beam receiving power of each first beam, and can also think of other ways of association between the second beam power and the beam receiving power of each second beam, which will not be repeatedly described here.

Hereinafter, description is made by taking the first beam power being an average of the beam receiving power of each first beam and the second beam power being an average of the beam receiving power of the second beam corresponding to each neighboring electronic device as an example.

In the actual system, in the initial access phase, the user equipment selects one base station and a corresponding beam to initiate random access according to a certain criterion (for example, adopting the maximum receiving power criterion or the maximum signal-to-interference and noise ratio criterion). If the access is successful, the base station and the user equipment that are associated with each other will perform BR, and finally determine a beam (generally a narrow beam at this time) used for a service. Accordingly, UA/BM can be considered to have been preliminarily solved, that is, a preliminary result of UA/BM is obtained. In the embodiments according to the present disclosure, it is assumed that the overloaded electronic device 400 has obtained the above-mentioned preliminary result of UA/BM.

In an embodiment according to the present disclosure, similarly to the symbol signs used above, it is assumed that there are K single-antenna users and J+1 electronic devices in total in the system. A channel from an electronic device with a serial number i (0 [symbol] i [symbol] J) to the k-th user equipment (1 [symbol] k [symbol] K) is denoted as h_{i,k}, for the electronic device with the serial number i (0 [symbol] i [symbol] J), the number of configurable beams is denoted as Bᵢ, a transmit power is denoted as ρᵢ, a beamforming matrix as used is denoted as Wᵢ, and a corresponding set of associated users is denoted as [symbol] . For the convenience of description, the electronic device 400 is represented by a serial number i=0, and the neighboring electronic device adjacent to the electronic device 400 is represented by a serial number 1 [symbol] i [symbol] J.

Hereinafter, for a system (communication network) comprising the electronic device 400 and the neighboring electronic device adjacent to the electronic device 400, the performance of the system is described by taking the sum rate of the system as an example. However, those skilled in the art can understand that the performance of the system may also be evaluated by indices such as the throughput of the system, or by the maximum rate of VIP users, etc.

In an embodiment according to the present disclosure, the sum rate C of the system comprising the electronic device 400 and the neighboring electronic device adjacent to the electronic device 400 may be simplified as:

$$C = {C}_{0} = {\sum }_{k ∈ {𝕂}_{\text{?}}} {log}_{2} ( 1 + \frac{\frac{{ρ}_{0}}{\vert {𝕂}_{0} \vert} {‖ {h}_{0 , \text{?}}^{H} {W}_{0} ‖}^{2}}{{\sum }_{j \text{?}} ( {mean }_{n} {P}_{k , j}^{( n )} ) + {σ}^{2}} ) \qquad ( Equation 6 )$$

$$\text{?} \text{indicates text missing or illegible when filed}$$

In Equation 6, C₀ represents the sum rate of the electronic device 400, P represents a beam power of an access beam, and a serial number of an access beam of each electronic device is represented by a serial number n. For the electronic device 400 with the serial number i=0, 1 [symbol] n [symbol] B₀, P_{k,j}⁽ⁿ⁾ represents a beam power of the n-th access beam received by the k-th user (k∈ [symbol] ) from an electronic device with a serial number j (j≠0), and mean represents calculating the mean.

In Equation 6,

$${mean }_{n} {P}_{k , j}^{( n )} ( j \neq 0 ,$$

k∈ [symbol] ₀) in

$${\sum }_{k ∈ {𝕂}_{\text{?}}} {log}_{2} ( 1 + \frac{\frac{{ρ}_{0}}{\vert {𝕂}_{0} \vert} {‖ {h}_{0 , \text{?}}^{H} {W}_{0} ‖}^{2}}{{\sum }_{j \text{?}} ( {mean }_{n} {P}_{k , j}^{( n )} ) + {σ}^{2}} )$$

$$\text{?} \text{indicates text missing or illegible when filed}$$

represents a first beam power corresponding to the overloaded electronic device 400, that is, represents a first beam power of an access beam received by the first user equipment corresponding to the overloaded electronic device 400 from the neighboring electronic device with the serial number j adjacent to the overloaded electronic device 400.

As an example, the balancing unit 402 may be configured to calculate performance of the overloaded electronic device 400 after offloading the at least part of user equipments from the overloaded electronic device 400, and to determine the at least part of the user equipments in a case of making the performance improved relative to performance of the overloaded electronic device 400 before the offloading is performed.

As an example, the above-mentioned performance comprises the sum rate of the overloaded electronic device 400.

If one user equipment is offloaded from the overloaded electronic device 400 and the serial number of the offloaded user equipment is denoted as k₀, then a change in the sum rate of the overloaded electronic device 400 after the user equipment is offloaded from the overloaded electronic device 400 may be expressed by Equation 7:

$$Δ {C}_{0} ( {k}_{0} ) = {\sum }_{k ∈ {𝕂}_{\text{?}} / \text{?}} {log}_{2} ( 1 + \frac{\frac{{ρ}_{0}}{\vert {𝕂}_{0} \vert - 1} {\vert {h}_{0 , \text{?}}^{H} {W}_{0} \vert}^{2}}{{\sum }_{j \text{?} 0} ( {mean }_{n} {P}_{k , j}^{( n )} ) + {σ}^{2}} ) - {\sum }_{k ∈ {𝕂}_{\text{?}}} {log}_{2} ( 1 + \frac{\frac{{ρ}_{0}}{\vert {𝕂}_{0} \vert} {\vert {h}_{0 , \text{?}}^{H} {W}_{0} \vert}^{2}}{{\sum }_{j \text{?}} ( {mean }_{n} {P}_{k , j}^{( n )} ) + {σ}^{2}} ) \qquad ( Equation 7 )$$

$$\text{?} \text{indicates text missing or illegible when filed}$$

In Equation 7, [symbol] ₀/(k₀) represents removing the user equipment with the serial number k₀ from the set [symbol] ₀ of associated users corresponding to the overloaded electronic device 400, i.e., offloading the user equipment with the serial number k₀ from the overloaded electronic device 400. In Equation 7,

$${\sum }_{k ∈ {𝕂}_{\text{?}} / \text{?}} {log}_{2} ( 1 + \frac{\frac{{ρ}_{0}}{\vert {𝕂}_{0} \vert - 1} {\vert {h}_{0 , \text{?}}^{H} {W}_{0} \vert}^{2}}{{\sum }_{j \text{?} 0} ( {mean }_{n} {P}_{k , j}^{( n )} ) + {σ}^{2}} )$$

$$\text{?} \text{indicates text missing or illegible when filed}$$

represents the sum rate of the overloaded electronic device 40 after offloading the user equipment with the serial number k₀ from the overloaded electronic device 400, and

$${\sum }_{k ∈ {𝕂}_{\text{?}}} {log}_{2} ( 1 + \frac{\frac{{ρ}_{0}}{\vert {𝕂}_{0} \vert} {\vert {h}_{0 , \text{?}}^{H} {W}_{0} \vert}^{2}}{{\sum }_{j \text{?} 0} ( {mean }_{n} {P}_{k , j}^{( n )} ) + {σ}^{2}} )$$

$$\text{?} \text{indicates text missing or illegible when filed}$$

represents the sum rate of the overloaded electronic device 40 before offloading the user equipment with the serial number k₀ from the overloaded electronic device 400.

In an embodiment according to the present disclosure, an amount of a change in the sum rate of the system comprising the overloaded electronic device 400 and the above-mentioned at least one neighboring electronic device after offloading the user equipment with the serial number k₀ from the overloaded electronic device 400 is estimated as ΔC₀(k₀).

In an embodiment according to the present disclosure, it is possible to determine the above-mentioned at least part of user equipments (i.e., user equipment with the serial number k₀) by calculating the serial number k₀ that makes ΔC₀(k₀) in Equation 7 positive (i.e., makes the amount of the change in the sum rate of the overloaded electronic device 400 positive).

As stated above, in Equation 7, a low-complexity algorithm is employed to perform local optimization for the system performance (e.g., sum rate of the system). The way of local optimization can greatly reduce the calculation complexity of the system compared with the way of global optimization of Equation 5 in the GUA method, and in addition, can effectively improve the performance of the system (for example, improve the sum rate of the overloaded electronic device 400) compared with the CRE method.

As an example, it is possible to determine the above-mentioned at least part (i.e., user equipment with the serial number k*₀) of user equipments by calculating the serial number k*₀ that makes ΔC₀(k₀) in Equation 7 positive and ΔC₀(k₀) maximum (i.e., makes the amount of the change in the sum rate of the overloaded electronic device 400 positive and the amount of the change maximum). The way of optimization may be expressed by the following Equation 8.

$$( {k}_{0}^{\text{?}} ) = arg {max}_{{k}_{0} ∈ {𝕂}_{0}} Δ C ( {k}_{0} ) \qquad ( Equation 8 )$$

$$\text{?} \text{indicates text missing or illegible when filed}$$

In Equation 8,

$$arg \text{?} Δ C ( {k}_{0} )$$

$$\text{?} \text{indicates text missing or illegible when filed}$$

represents calculating k₀ that makes ΔC₀(k₀) maximum. In Equation 8, k₀ that makes ΔC₀(k₀) positive and maximum is denoted as k*₀.

It should be noted that, if the amount of the change in the sum rate is negative, i.e., ΔC₀(k₀) [symbol] 0, it is not required to offload the user equipment from the overloaded electronic device 400.

As an example, the balancing unit 402 may be configured to continuously perform the offloading, until the performance of the overloaded electronic device 400 after the offloading is performed is not improved compared with the performance of the overloaded electronic device 400 before the offloading is performed.

As an example, upon completion of offloading of one user equipment from the overloaded electronic device 400, the offloading may be performed repeatedly so as to achieve the effect of continuously offloading multiple user equipments and persistently improving the sum rate of the overloaded electronic device 400, and is not stopped until the amount of the change in the sum rate of the overloaded electronic device 400 is negative.

In another embodiment according to the present disclosure, the sum rate C of the system comprising the electronic device 400 and the neighboring electronic devices adjacent to the electronic device 400 may also be expressed as:

$$C = \text{?} = {log}_{2} ( 1 + \text{?} ) + \text{?} {log}_{2} ( 1 + \text{?} ) \qquad ( Equation 9 )$$

$$\text{?} \text{indicates text missing or illegible when filed}$$

In Equation 9, C₀ represents the sum rate of the electronic device 400 (see Equation 6), Cᵢ represents the sum rate of the neighboring electronic device with the serial number i (1 [symbol] i [symbol] J), P represents a beam power of an access beam, and a serial number of an access beam of each electronic device is represented by a serial number n. For the electronic device with a serial number i (0 [symbol] i [symbol] J), 1 [symbol] n [symbol] Bᵢ, P_{k,j}⁽ⁿ⁾ in

$$\text{?} {log}_{2} ( 1 + \text{?} )$$

$$\text{?} \text{indicates text missing or illegible when filed}$$

represents a beam power of the n-th access beam received by the k-th user (k∈ [symbol] ᵢ) from an electronic device with a serial number j (1 [symbol] i [symbol] J, j≠i), and mean represents calculating the mean.

In Equation 9, meanₙP_{k,j}⁽ⁿ⁾ (1 [symbol] i [symbol] J, j≠i, k∈ [symbol] ᵢ) in

$$\text{?} {log}_{2} ( 1 + \text{?} )$$

$$\text{?} \text{indicates text missing or illegible when filed}$$

represents a second beam power corresponding to the neighboring electronic device with the serial number i, that is, represents a second beam power received by a second user equipment corresponding to the neighboring electronic device with the serial number i from an electronic device (i.e., an electronic device, other than the neighboring electronic device with the serial number i, among the overloaded electronic device 400 and the at least one neighboring electronic device) that is not associated with the second user equipment among the overloaded electronic device 400 and the at least one neighboring electronic device.

As an example, the balancing unit 402 may be configured to calculate performance of the overloaded electronic device 400 and the at least one neighboring electronic device after offloading the at least part of user equipments from the overloaded electronic device 400 and associating the offloaded user equipments with a selected neighboring electronic device among the at least one neighboring electronic device, to determine the at least part of the user equipments and the selected neighboring electronic device in a case of making the performance improved relative to performance of the overloaded electronic device 400 and the at least one neighboring electronic device before the offloading is performed.

As an example, the above-mentioned performance comprises the sum rate of the overloaded electronic device 400 and the sum rate of the neighboring electronic device. As stated above, for a system comprising the electronic device 400 and the neighboring electronic device adjacent to the electronic device 400, the performance of the system may also be evaluated by indices such as the throughput of the system, or by making rate of VIP users to be maximum, etc. Hereinafter, description is made still by taking the performance being the sum rate as an example.

A change in the sum rate of the neighboring electronic device with the serial number i after offloading the user equipment with the serial number k₀ from the overloaded electronic device 400 and associating the offloaded user equipment with the neighboring electronic device with the serial number i may be expressed by Equation 10:

$$Δ \text{?} ( {k}_{0} ) = \text{?} {log}_{2} ( 1 + \text{?} ) - \text{?} {log}_{2} ( 1 + \text{?} )$$

$$\text{?} \text{indicates text missing or illegible when filed}$$

In Equation 10, [symbol] ᵢ [symbol] {k₀} represents adding the user equipment with the serial number k₀ into a corresponding set [symbol] ᵢ of associated users corresponding to the neighboring electronic device with the serial number i, i.e., associating the user equipment with the serial number k₀ with the neighboring electronic device with the serial number i (serving the user equipment with the serial number k₀ by the neighboring electronic device with the serial number i). In Equation 8,

$$\text{?} {log}_{2} ( 1 + \text{?} )$$

$$\text{?} \text{indicates text missing or illegible when filed}$$

represents the sum rate of the neighboring electronic device with the serial number i after associating the user equipment with the serial number k₀ with the neighboring electronic device with the serial number i, and

$$\text{?} {log}_{2} ( 1 + \text{?} )$$

$$\text{?} \text{indicates text missing or illegible when filed}$$

represents the sum rate of the neighboring electronic device with the serial number i before associating the user equipment with the serial number k₀ with the neighboring electronic device with the serial number i.

An amount of a change in the sum rate of the system comprising the overloaded electronic device 400 and the above-mentioned at least one neighboring electronic device after offloading the user equipment with the serial number k₀ from the overloaded electronic device 400 and associating the offloaded user equipment with the neighboring electronic device with the serial number i is estimated as:

ΔC(i,k₀)≈ΔC₀(k₀)+ΔCᵢ(k₀) (Equation 11)

It is possible to determine the above-mentioned at least part (i.e., the user equipment with the serial number k₀) of user equipments and the selected neighboring electronic device (i.e., the neighboring electronic device with the serial number i) by calculating the serial number i and the serial number k₀ that make ΔC(i, k₀) in Equation 11 positive (i.e., make the amount of the change in the sum rate of the system positive).

As stated above, in Equation 11, a low-complexity algorithm is employed to perform local optimization for the system performance (e.g., the sum rate of the system). The way of local optimization can greatly reduce the calculation complexity of the system compared with the way of global optimization of Equation 5 in the GUA method, and in addition, can effectively improve the performance of the system (for example, improve the sum rate of the system) compared with the CRE method.

As an example, it is possible to determine the above-mentioned at least part (i.e., user equipment with the serial number k*₀) of user equipments and the selected neighboring electronic device (i.e., the neighboring electronic device with the serial number i*) by calculating the serial number i* and the serial number k*₀ that make ΔC(i, k₀) in Equation 11 positive and ΔC(i, k₀) maximum (i.e., make the amount of the change in the sum rate of the system positive and the amount of the change maximum). The way of optimization may be expressed by the following Equation 12.

$$( \text{?} ) = arg \text{?} ΔC ( i , {k}_{0} ) \qquad ( Equation 12 )$$

$$\text{?} \text{indicates text missing or illegible when filed}$$

In Equation 12,

$$arg \text{?}$$

$$\text{?} \text{indicates text missing or illegible when filed}$$

represents calculating i and k₀ that make ΔC(i, k₀) maximum. In Equation 12, i and k₀ that make ΔC(i, k₀) positive and maximum are denoted as i* and k*₀.

It should be noted that, if the amount of the change in the sum rate is negative, i.e., ΔC(i, k₀)≤0, it is not required to offload the user equipment from the overloaded electronic device 400.

As an example, the balancing unit 402 may be configured to continuously perform the offloading, until the performance of the overloaded electronic device 400 and the above-mentioned at least one neighboring electronic device after the offloading is performed is not improved compared with the performance of the overloaded electronic device 400 and the above-mentioned at least one neighboring electronic device before the offloading is performed

As an example, upon completion of offloading of one user equipment from the overloaded electronic device 400, the offloading may be performed repeatedly so as to achieve the effect of continuously offloading multiple user equipments and persistently improving the sum rate of the system, and is not stopped until the amount of the change in the sum rate of the system is negative.

As an example, the balancing unit 402 may be configured to notify the above-mentioned at least part of user equipments of offloading from the overloaded electronic device 400 and provide information about the selected neighboring electronic device to the above-mentioned at least part of user equipments. As such, the above-mentioned at least part of user equipments is offloaded from the overloaded electronic device 400 and may attempt to be associated with the selected neighboring electronic device.

As an example, the balancing unit 402 may be configured to notify the above-mentioned at least one neighboring electronic device of performing the load balancing, and each neighboring electronic device notifies a second user equipment associated with the neighboring electronic device of measuring the second beam power. As an example, each neighboring electronic device communicates the second beam power corresponding thereto to the overloaded electronic device 400 through an information interaction interface between base stations.

As an example, the balancing unit 402 may be configured to receive from each neighboring electronic device the second beam power reported by a second user equipment associated with the neighboring electronic device to the neighboring electronic device. As an example, the second user equipment associated with each neighboring electronic device reports the measured second beam power to the neighboring electronic device, and the neighboring electronic device communicates the second beam power to the overloaded electronic device 400.

FIG. 5 shows exemplary information flow about offloading among the overloaded electronic device 400, the neighboring electronic device, the first user equipment, and the second user equipment according to an embodiment of the present disclosure.

As shown in FIG. 5, (1) the overloaded electronic device 400 initiates an offloading operation, notifies the neighboring electronic device of the offloading operation to be performed, and notifies the first user equipment associated with the overloaded electronic device 400 of measuring a first beam power of an access beam of the neighboring electronic device in the system; (2) after receiving an offloading notification, the neighboring electronic device notifies its associated second user equipment, to let the second user equipment measure a second beam power of a access beam of an electronic device other than the neighboring electronic device in the system; (3) the first user equipment reports the measured first beam power to the overloaded electronic device 400, and the second user equipment reports the measured second beam power to the neighboring electronic device associated with the second user equipment; (4) the neighboring electronic device communicates the second beam power reported by the second user equipment associated therewith to the overloaded electronic device 400; (5) after determining a user equipment to be offloaded and a neighboring electronic device to be associated with the user equipment to be offloaded based on the information of (3) and (4), the overloaded electronic device 400 notifies the user equipment to be offloaded of offloading from the overloaded electronic device 400 and notifies it of an neighboring electronic device to be associated therewith; (6) the user equipment to be offloaded is offloaded from the overloaded electronic device 400 and attempts to be associated with the neighboring electronic device to be associated therewith.

Hereinafter, performance of performing load balancing by the overloaded electronic device 400 according to the embodiment of the present disclosure will be shown. For the convenience of description, a method of performing load balancing by the overloaded electronic device 400 according to the embodiment of the present disclosure is referred to as an OS (Offloading Strategy) method.

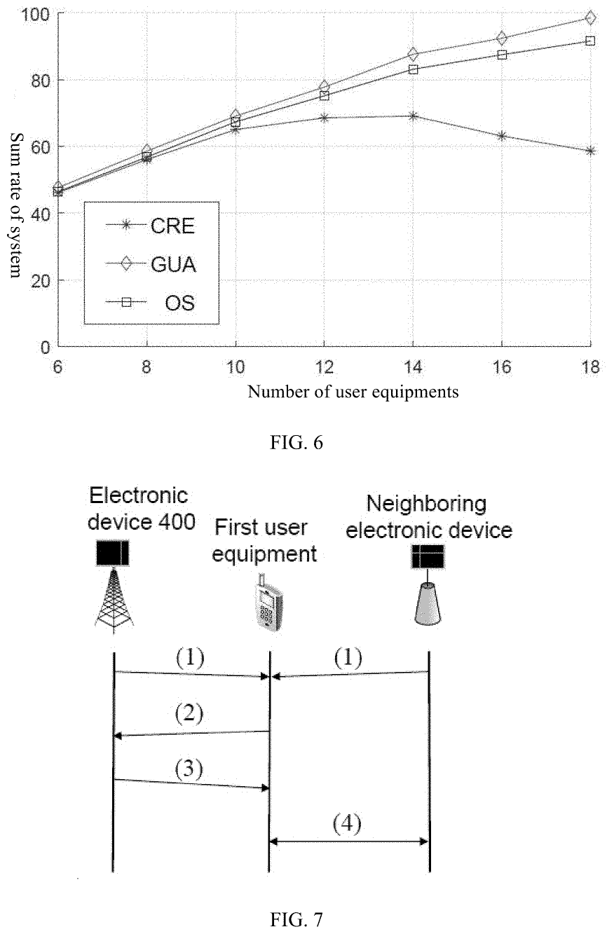

FIG. 6 is an exemplary diagram showing performance of performing load balancing by the CRE method, the GUA method, and the OS method according to an embodiment of the present disclosure.

As an example, in FIG. 6, a system sum rate (bps/Hz) obtained when load balancing is performed by the CRE method, the GUA method, and the OS method according to the embodiment of the present disclosure is shown. As shown in FIG. 6, the system sum rate of the GUA method is the highest, but as mentioned above, the GUA method has huge overhead and very high calculation complexity in acquiring CSI; the CRE method causes uneven system load, thereby seriously affecting the sum rate of the system, and especially when the number of user equipments is large, the sum rate of the system is lower; the sum rate of the system by the OS method according to the embodiment of the present disclosure has been increased compared with the sum rate of the system by the CRE method, and moreover, as mentioned above, the OS method significantly reduces calculation complexity and reduces system overhead compared with the GUA method, and thus is more prone to obtain application in the actual system, thus achieving a compromise between performance and realizability.

In the above, the processing of the load balancing performed by the overloaded electronic device 400 for the first user equipment that has accessed the overloaded electronic device 400 has been described.

Hereinafter, processing of load balancing performed by the overloaded electronic device 400 for a user equipment that initiates initial access to the overloaded electronic device 400 will be described.

As an example, the first user equipment is a user equipment that initiates initial access to the overloaded electronic device 400, and the balancing unit 402 may be configured to perform the load balancing further based on a third beam power of a third beam received by the first user equipment from the overloaded electronic device 400, wherein the third beam is scanned for initial access of the user equipment.

As mentioned above, in order to support initial access of a new user equipment, each base station will periodically perform beam scanning, that is, the base station will broadcast a synchronization signal with each beam in turn according to a predetermined beam codebook. In an initial access phase, a user equipment will measure a beam power of a beam from a neighboring base station adjacent thereto, wherein the beam is scanned for initial access of the user equipment.

For the first user equipment that initiates initial access to the overloaded electronic device 400, the overloaded electronic device 400 according to the embodiment of the present disclosure performs load balancing based on the first beam power received by the first user equipment from the neighboring electronic device and the third beam power received from the overloaded electronic device 400, without requiring to additionally configure a reference signal (i.e., without requiring additional overhead), and thus the system overhead can be greatly saved, and thereby user association and beam management of a newly accessing user equipment are effectively implemented.

As an example, the balancing unit 402 may be configured to determine whether the first user equipment is allowed to access the overloaded electronic device 400 based on the first beam power and the third beam power. That the first user equipment accesses the overloaded electronic device 400 refers to that the first user equipment is served by the overloaded electronic device 400.

As an example, the first beam power is a weighted mean of a beam receiving power of each first beam, and the third beam power is a weighted mean of a beam receiving power of each third beam.

Hereinafter, description is made by taking the first beam power being a weighted mean of a beam receiving power of each first beam and the third beam power being a weighted mean of a beam receiving power of each third beam as an example. In addition to the weighted mean, those skilled in the art can also think of other ways of association between the first beam power and the beam receiving power of each first beam, and can also think of other ways of association between the third beam power and the receiving beam of each third beam, which will not be repeatedly described here.

Similarly to the symbol signs used above, it is assumed that there are J+1 base stations in total in the system, the electronic device 400 is represented by a serial number j=0, the neighboring electronic device adjacent to the electronic device 400 is represented by a serial number 1 [symbol] j [symbol] J, and the number of configurable beams of the electronic device with the serial number j is (0 [symbol] j [symbol] J) is Bⱼ.

As an example, the balancing unit 402 may be configured to calculate an optimal electronic device to be associated with the first user equipment and an optimal beam of the optimal electronic device based on the first beam power and the third beam power and to, in a case of determining that the overloaded electronic device 400 is not the optimal electronic device, refuse the first user equipment to access the overloaded electronic device 400 and inform the first user equipment of information about the optimal electronic device and the optimal beam. The processing may be expressed by, for example, the following Equation 13.

$$( \text{?} ) = arg \text{?} {log}_{2} ( 1 + \text{?} ) \qquad ( Equation 13 )$$

$$\text{?} \text{indicates text missing or illegible when filed}$$

In Equation 13, P represents a beam power of an access beam, and a serial number of an access beam of each electronic device is represented by a serial number n. For the electronic device with the serial number j (0 [symbol] j [symbol] J), 1 [symbol] n [symbol] Bⱼ, P_{k,j}⁽ⁿ⁾ represents a beam power of the n-th access beam received by the first user equipment (denoted as user with a serial number k) from an electronic device with a serial number j (j≠i, 0 [symbol] i [symbol] J), 0 [symbol] i [symbol] J, 1 [symbol] m [symbol] Bₘ, and mean represents calculating the mean.

In Equation 13, when 1 [symbol] j [symbol] J,

$$\text{?}$$

$$\text{?} \text{indicates text missing or illegible when filed}$$

represents the first beam power received by the first user equipment from each neighboring electronic device, and when j=0,

$$\text{?}$$

$$\text{?} \text{indicates text missing or illegible when filed}$$

represents the third beam power received by the first user equipment from the overloaded electronic device 400.

$$arg \text{?}$$

$$\text{?} \text{indicates text missing or illegible when filed}$$

represents calculating values of i and m when making

$${log}_{2} ( 1 + \text{?} )$$

$$\text{?} \text{indicates text missing or illegible when filed}$$

reach the maximum values. In Equation 13, i and m that make

$${log}_{2} ( 1 + \text{?} )$$

$$\text{?} \text{indicates text missing or illegible when filed}$$

reach the maximum values are denoted as i* and m*, respectively. More specifically, i* is the serial number of the calculated optimal electronic device to be associated with the first user equipment, and m* is the calculated optimal beam of the optimal electronic device.

It should be noted that, although the first beam power and the third beam power are included in Equation 13, a value of i in Equation 13 may be made to be only taken as 0 (i=0 represents the electronic device 400), and P_{k,i}^{(m)} (i=0, m=1, . . . , B₀) on the numerator may be respectively replaced by a beam power of a corresponding beam received by the first user equipment from a neighboring electronic device that is the most adjacent to the electronic device 400 with the serial number i=0, wherein B₀ is the number of configurable beams of the electronic device 400. That is to say, the electronic device 400 may perform load balancing (for example, determine whether to allow the first user equipment to access) based only on the first beam power.

As an example, the balancing unit 402 may be configured to insert in the third beam an identification indicating whether a load of the electronic device 400 is greater than the predetermined threshold. As an example, the electronic device 400 may add 1-bit indication information to the synchronization information transmitted in the beam scanning phase, to indicate whether the electronic device 400 is overloaded. As such, the first user equipment that attempts to access the electronic device 400 can be made to know the load state of the electronic device 400.

As an example, the balancing unit 402 may be configured to receive information about the first beam power from the first user equipment.

FIG. 7 shows exemplary information flow about refusing access among the electronic device 400, the neighboring electronic device, and the first user equipment according to an embodiment of the present disclosure.

As shown in FIG. 7, (1) the electronic device 400 transmits an identification indicating whether its load is greater than a predetermined threshold in the beam scanning phase; (2) the first user equipment initiates random access to the electronic device 400, the first user equipment reports the first beam power of the access beam of the neighboring electronic device to the electronic device 400 in a case of knowing that the electronic device 400 is overloaded according to the above-mentioned identification; (3) the electronic device 400 informs the first user equipment of information on the optimal electronic device to which it is to be accessed and the optimal beam in a reply phase of the random access; (4) if the optimal electronic device is not the electronic device 400 (i.e., a access request sent by the first user equipment to the electronic device 400 is refused), then the first user equipment attempts to initiate access to the optimal beam of the optimal electronic device (in FIG. 7, it is assumed that the optimal electronic device is the neighboring electronic device as shown).

The above embodiments describe embodiments on base station side, and embodiments on UE side are next described.

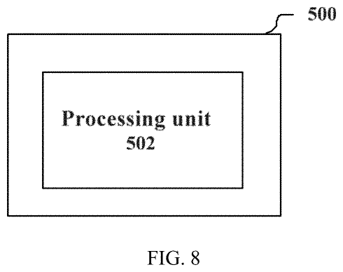

FIG. 8 shows a block diagram of functional modules of an electronic device 500 according to another embodiment of the present disclosure. As shown in FIG. 8, the electronic device 500 comprises a processing unit 502, which may be configured to: in a case where a base station is an overloaded base station whose load is greater than a predetermined threshold, measure a beam power of a beam received from each of at least one neighboring base station of the overloaded base station, for the overloaded base station to perform load balancing, wherein the beam is scanned for initial access of the electronic device.

Wherein, the processing unit 502 may be implemented by one or more processing circuitries which may be implemented as, for example, a chip.

The electronic device 500 may be arranged on user equipment side or communicably connected to a user equipment, for example. It should also be noted herein that, the electronic device 500 may be implemented at chip level or at device level. For example, the electronic device 500 may work as a user equipment itself, and may also include external devices such as a memory, a transceiver (not shown in the figure) and the like. The memory may be used to store programs and related data information that the user equipment needs to execute in order to implement various functions. The transceiver may include one or more communication interfaces to support communication with different devices (e.g., a base station, other user equipment, etc.), and the implementation form of the transceiver is not specifically limited here.

As an example, the predetermined threshold may be set according to actual needs.

As an example, the overloaded base station may be an apparatus with relatively strong service capability, for example, may be a macro base station in a heterogeneous network.

As an example, the neighboring base station may comprise an underloaded base station whose load is less than or equal to the predetermined threshold, and the underloaded base station may be, for example, a micro base station in a heterogeneous network. In a local heterogeneous network, a coverage range of a micro base station is generally included in a coverage range of a neighboring macro base station. As an example, the neighboring base station may also be other overloaded base stations.

As an example, the neighboring electronic device of the overloaded base station (e.g., macro base station) may comprise at least one of: all base stations covered within the coverage range of the overloaded base station; at least one other base station within a predetermined range from the overloaded base station; all base stations covered within the coverage range of the above-mentioned at least one other base station.

As mentioned above, in order to support initial access of a new user equipment, each base station will periodically perform beam scanning, that is, the base station will broadcast a synchronization signal with each beam in turn according to a predetermined beam codebook. In an initial access phase, an electronic device will measure a beam power of a beam from a neighboring base station adjacent thereto, wherein the beam is scanned for initial access of the electronic device. Those skilled in the art can understand that both electronic device within the service range of the base station and electronic device not within the service range of the base station can measure the beam power of the beam (access beam) scanned by a base station for initial access of an electronic device.

As discussed in combination with Equation 5 when describing the GUA method, in the GUA method, h_{j,k} (j≠0, k∈ [symbol] ₀) is the CSI between the user equipment associated with the current base station and the base station that is not associated with the user equipment, which cannot be obtained through direct measurements, and thus acquiring h_{j,k} is the main source of the system overhead. In the electronic device 500 according to the embodiment of the present disclosure, by measuring a beam power of an access beam received from the neighboring base station of the overloaded base station for the overloaded base station to perform load balancing, thus the overloaded base station can obtain channel state information between each neighboring base station and the electronic device 500 without additionally configuring a reference signal (i.e. without requiring additional overhead), and thus the system overhead can be greatly saved.

As an example, the electronic device 500 is an electronic device associated with the overloaded base station, and the processing unit 502 may be configured to report information about the beam power to the overloaded base station when receiving a notification of performing the load balancing from the overloaded base station.

As an example, that the electronic device 500 is an electronic device associated with the overloaded base station refers to that the electronic device 500 is an electronic device within the service range of the overloaded base station, that is, the electronic device 500 is served by the overloaded base station.

As an example, the processing unit 502 may be configured to be disassociated with the overloaded base station after receiving from the overloaded base station a notification to offload from the overloaded base station. As an example, being disassociated with the overloaded base station refers to that the electronic device 500 is no longer served by the overloaded base station.

As an example, the processing unit 502 may be configured to be associated with a neighboring base station to be accessed that is selected from the at least one neighboring base station after receiving information about the neighboring base station to be accessed from the overloaded base station.

For processing that the overloaded base station selects a neighboring base station that the electronic device 500 is to access from the at least one neighboring base station, reference may be made to the description about Equation 12 in the electronic device 400 according to the embodiment of the present application (hereinafter, also referred to as base station 400 sometimes).

For exemplary information flow about offloading among the electronic device 500, the overloaded base station and the neighboring base station, reference may be made to the exemplary information flow as shown in FIG. 5.

As an example, the electronic device 500 may be an electronic device that initiates initial access to the base station, and the processing unit 502 may be configured to report information about the beam power to the overloaded base station, in a case of determining that the base station is the overloaded base station based on a message indicating whether a load of the base station is greater than the predetermined threshold.

As mentioned in the above description of the base station 400 according to the embodiment of the disclosure, the base station 400 may insert in the third beam an identification indicating whether a load of the base station 400 is greater than the predetermined threshold.

As an example, the electronic device 500 that initiates initial access to the base station, in a case of determining from the above-mentioned identification that the base station is an overloaded base station, reports information about a beam power of an access beam received by it from each neighboring base station to the overloaded base station.

As an example, the processing unit 502 may be configured to receive from the overloaded base station a message on whether access to the overloaded base station is allowed.

As an example, the processing unit 502 may be configured to attempt to access a neighboring base station recommended to be accessed that is selected from the above-mentioned at least one neighboring base station after receiving from the overloaded base station a notification of refusing access and information about the neighboring base station recommended to be accessed, to be associated with the neighboring base station recommended to be accessed in a case of successful access.

For processing that the overloaded base station selects a neighboring base station that the electronic device 500 is to access from the above-mentioned at least one neighboring base station, reference may be made to the description about Equation 13 in the base station 400 according to the embodiment of the present application.

For exemplary information flow about refusing access among the electronic device 500, the overloaded base station and the neighboring base station, reference may be made to the exemplary information flow as shown in FIG. 7.

As an example, the processing unit 502 may be configured to receive a message indicating whether a load of the base station is greater than the predetermined threshold from a beam scanned by the base station for initial access.

As an example, the beam power is a weighted mean of a beam receiving power corresponding to each beam.

In the process of describing the electronic devices for wireless communications in the above implementations, some processing or methods obviously have also been disclosed. Hereinafter, an outline of these methods will be given without repeating some of the details that have been discussed above; however, it should be noted that, although these methods are disclosed in the process of describing electronic devices for wireless communications, these methods do not necessarily employ those components as described or are not necessarily executed by those components. For example, the implementations of the electronic devices for wireless communications may be partially or completely realized using hardware and/or firmware, while the methods for wireless communications discussed below may be completely implemented by a computer-executable program, although these methods may also employ hardware and/or firmware of the electronic devices for wireless communications.

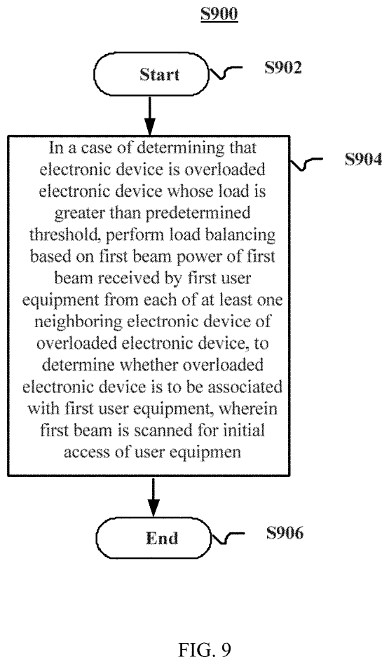

FIG. 9 shows a flowchart of a method S900 for wireless communications according to an embodiment of the present disclosure. The method S900 starts in step S902. In step S904, in a case of determining that an electronic device is an overloaded electronic device whose load is greater than a predetermined threshold, load balancing is performed based on a first beam power of a first beam received by a first user equipment from each of at least one neighboring electronic device of the overloaded electronic device, to determine whether the overloaded electronic device is to be associated with the first user equipment, wherein the first beam is scanned for initial access of the user equipment. The method S900 ends in step S906. The method S900 may be executed on the base station side.

The method may be executed by, for example, the electronic device 400 as described in the first embodiment. Please refer to the description at the above corresponding position for specific details, which will not be repeated here.

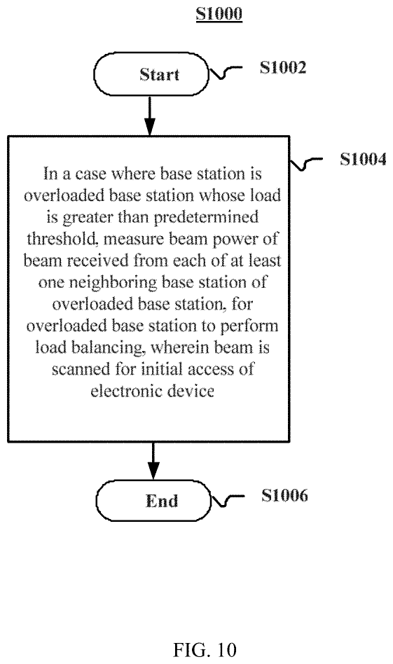

FIG. 10 shows a flowchart of a method S1000 for wireless communications according to another embodiment of the present disclosure. The method S1000 starts in step S1002. In step S1004, in a case where a base station is an overloaded base station whose load is greater than a predetermined threshold, a beam power of a beam received from each of at least one neighboring base station of the overloaded base station is measured, for the overloaded base station to perform load balancing, wherein the beam is scanned for initial access of an electronic device. The method S1000 ends in step S1006. The method S1000 may be executed on the UE side.

The method may be executed by, for example, the electronic device 500 as described in the first embodiment. Please refer to the description at the above corresponding position for specific details, which will not be repeated here.

Note that, each of the above-mentioned methods may be used in combination or alone.

The technology of the present disclosure can be applied to various products.

For example, the electronic device 400 may be implemented as various base stations. The base station may be implemented as any type of evolved Node B (eNB) or gNB (5G base station). An eNB includes, for example, macro eNBs and small eNBs. A small eNB may be an eNB that covers a cell smaller than a macro cell, such as a pico eNB, a micro eNB, and a home (femto) eNB. A similar situation can also apply to gNBs. Alternatively, the base station may be implemented as any other type of base station, such as a NodeB and a base transceiver station (BTS). The base station may include: a main body (also referred to as base station equipment) configured to control wireless communications; and one or more remote radio heads (RRHs) arranged at a different place from the main body. In addition, various types of user equipment can all operate as base stations by temporarily or semi-persistently performing base station functions.

For example, the electronic device 500 may be implemented as various user equipment. The user equipment may be implemented as a mobile terminal (such as a smart phone, a tablet personal computer (PC), a notebook PC, a portable game terminal, a portable/dongle type mobile router, and a digital camera) or a vehicle-mounted terminal (such as an automobile navigation device). The user equipment may also be implemented as a terminal (also referred to as a machine type communication (MTC) terminal) that executes Machine-to-Machine (M2M) communications. In addition, the user equipment may be a wireless communication module (such as an integrated circuit module including a single chip) installed on each of the above-mentioned terminals.

### Application Examples About Base Station

### First Application Example

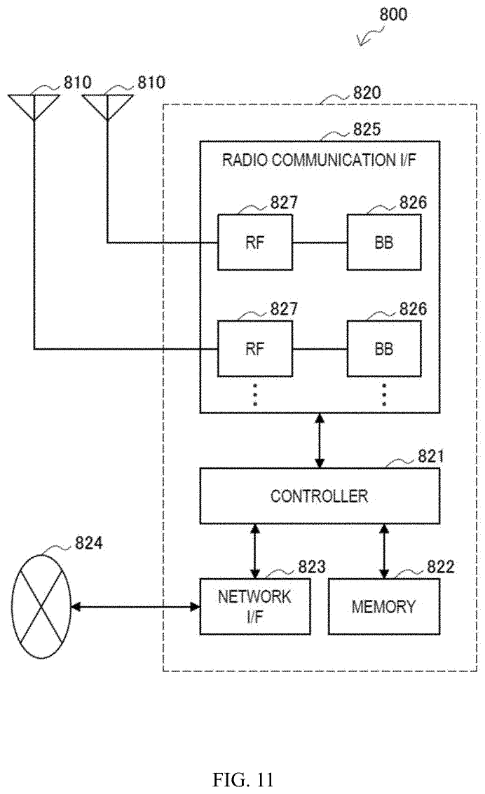

FIG. 11 is a block diagram showing a first example of a schematic configuration of an eNB or gNB to which the technology of the present disclosure can be applied. Note that, the following description takes an eNB as an example, but it may also be applied to a gNB. An eNB 800 includes one or more antennas 810 and base station equipment 820. The base station equipment 820 and each antenna 810 may be connected to each other via an RF cable.

Each of the antennas 810 includes a single or multiple antenna elements (such as multiple antenna elements included in a Multi-Input Multi-Output (MIMO) antenna), and is used for the base station equipment 820 to transmit and receive wireless signals. As shown in FIG. 11, the eNB 800 may include multiple antennas 810. For example, the multiple antennas 810 may be compatible with multiple frequency bands used by the eNB 800. Although FIG. 11 shows an example in which the eNB 800 includes multiple antennas 810, the eNB 800 may also include a single antenna 810.

The base station equipment 820 includes a controller 821, a memory 822, a network interface (I/F) 823, and a radio communication interface 825.

The controller 821 may be, for example, a CPU or a DSP, and manipulate various functions of a higher layer of the base station equipment 820. For example, the controller 821 generates a data packet based on data in a signal processed by the radio communication interface 825, and transfers the generated packet via the network interface 823. The controller 821 may bundle data from multiple baseband processors to generate a bundled packet, and transfer the generated bundled packet. The controller 821 may have a logical function for performing control such as radio resource control, radio bearer control, mobility management, admission control, and scheduling. The control may be executed in conjunction with nearby eNBs or core network nodes. The memory 822 includes an RAM and an ROM, and stores programs executed by the controller 821 and various types of control data (such as a terminal list, transmission power data, and scheduling data).

The network interface 823 is a communication interface for connecting the base station equipment 820 to a core network 824. The controller 821 may communicate with the core network node or another eNB via the network interface 823. In this case, the eNB 800 and the core network node or other eNBs may be connected to each other through a logical interface (such as an S1 interface and an X2 interface). The network interface 823 may also be a wired communication interface, or a wireless communication interface for a wireless backhaul line. If the network interface 823 is a wireless communication interface, the network interface 823 may use a higher frequency band for wireless communications than the frequency band used by the radio communication interface 825.

The radio communication interface 825 supports any cellular communication scheme (such as Long Term Evolution (LTE) and LTE-Advanced), and provides wireless connection to a terminal located in a cell of the eNB 800 via an antenna 810. The radio communication interface 825 may generally include, for example, a baseband (BB) processor 826 and an RF circuit 827. The BB processor 826 may execute, for example, encoding/decoding, modulation/demodulation, and multiplexing/demultiplexing, and execute various types of signal processing of layers (e.g., L1, Medium Access Control (MAC), Radio Link Control (RLC), and Packet Data Convergence Protocol (PDCP)). Instead of the controller 821, the BB processor 826 may have a part or all of the above-mentioned logical functions. The BB processor 826 may be a memory storing a communication control program, or a module including a processor and related circuits configured to execute the program. An update program may cause the function of the BB processor 826 to be changed. The module may be a card or blade inserted into a slot of the base station equipment 820. Alternatively, the module may also be a chip mounted on a card or blade. Meanwhile, the RF circuit 827 may include, for example, a mixer, a filter, and an amplifier, and transmit and receive a wireless signal via the antenna 810.

As shown in FIG. 11, the radio communication interface 825 may include multiple BB processors 826. For example, the multiple BB processors 826 may be compatible with multiple frequency bands used by the eNB 800. As shown in FIG. 11, the radio communication interface 825 may include multiple RF circuits 827. For example, the multiple RF circuits 827 may be compatible with multiple antenna elements. Although FIG. 11 shows an example in which the radio communication interface 825 includes multiple BB processors 826 and multiple RF circuits 827, the radio communication interface 825 may also include a single BB processor 826 or a single RF circuit 827.

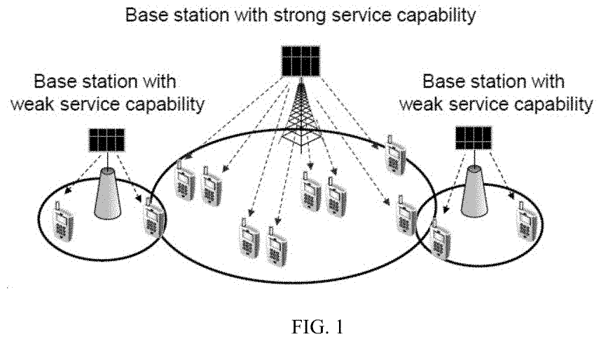

In the eNB 800 as shown in FIG. 11, the transceiver of the electronic device 400 may be implemented by a radio communication interface 825. At least a part of the function may also be implemented by the controller 821. For example, the controller 821 may perform user association and beam management by executing the function of the above-mentioned balancing unit 402 described with reference to FIG. 1.

### Second Application Example

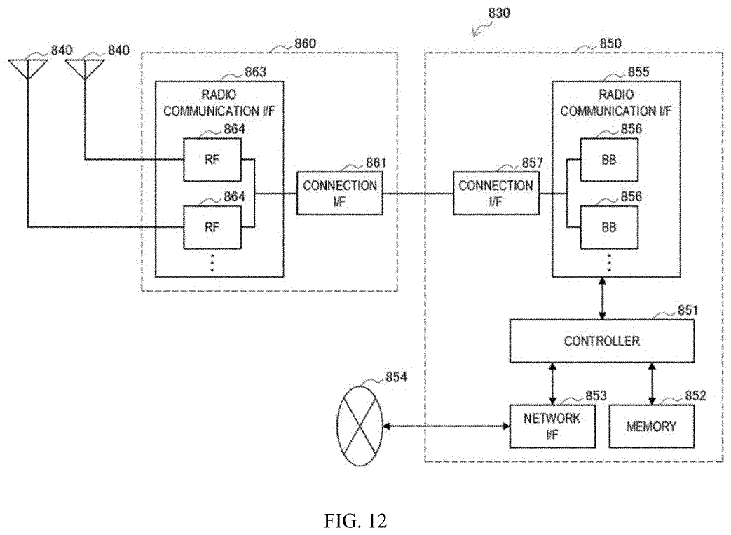

FIG. 12 is a block diagram showing a second example of a schematic configuration of an eNB or gNB to which the technology of the present disclosure can be applied. Note that similarly, the following description takes an eNB as an example, but it may also be applied to a gNB. An eNB 830 includes one or more antennas 840, base station equipment 850, and an RRH 860. The RRH 860 and each antenna 840 may be connected to each other via an RF cable. The base station equipment 850 and the RRH 860 may be connected to each other via a high-speed line such as an optical fiber cable.

Each of the antennas 840 includes a single or multiple antenna elements (such as multiple antenna elements included in a MIMO antenna) and is used for the RRH 860 to transmit and receive a wireless signal. As shown in FIG. 12, the eNB 830 may include multiple antennas 840. For example, the multiple antennas 840 may be compatible with multiple frequency bands used by the eNB 830. Although FIG. 12 shows an example in which the eNB 830 includes multiple antennas 840, the eNB 830 may also include a single antenna 840.

The base station equipment 850 includes a controller 851, a memory 852, a network interface 853, a radio communication interface 855, and a connection interface 857. The controller 851, the memory 852, and the network interface 853 are the same as the controller 821, the memory 822, and the network interface 823 as described with reference to FIG. 11.

The radio communication interface 855 supports any cellular communication scheme (such as LTE and LTE-Advanced), and provides wireless communications to a terminal located in a sector corresponding to the RRH 860 via the RRH 860 and the antenna 840. The radio communication interface 855 may generally include, for example, a BB processor 856. The BB processor 856 is the same as the BB processor 826 as described with reference to FIG. 11 except that the BB processor 856 is connected to the RF circuit 864 of the RRH 860 via the connection interface 857. As shown in FIG. 12, the radio communication interface 855 may include multiple BB processors 856. For example, the multiple BB processors 856 may be compatible with multiple frequency bands used by the eNB 830. Although FIG. 12 shows an example in which the radio communication interface 855 includes multiple BB processors 856, the radio communication interface 855 may also include a single BB processor 856.

The connection interface 857 is an interface for connecting the base station equipment 850 (radio communication interface 855) to the RRH 860. The connection interface 857 may also be a communication module for communication in the above-mentioned high-speed line that connects the RRH 860 to the base station equipment 850 (radio communication interface 855).

The RRH 860 includes a connection interface 861 and a radio communication interface 863.

The connection interface 861 is an interface for connecting the RRH 860 (radio communication interface 863) to the base station equipment 850. The connection interface 861 may also be a communication module for communication in the above-mentioned high-speed line.

The radio communication interface 863 transfers and receives wireless signals via the antenna 840. The radio communication interface 863 may generally include, for example, an RF circuit 864. The RF circuit 864 may include, for example, a mixer, a filter, and an amplifier, and transfer and receive wireless signals via the antenna 840. As shown in FIG. 12, the radio communication interface 863 may include multiple RF circuits 864. For example, the multiple RF circuits 864 may support multiple antenna elements. Although FIG. 12 shows an example in which the radio communication interface 863 includes multiple RF circuits 864, the radio communication interface 863 may also include a single RF circuit 864.

In the eNB 830 as shown in FIG. 12, the transceiver of the electronic device 400 may be implemented by the radio communication interface 855. At least a part of the function may also be implemented by the controller 851. For example, the controller 851 may perform user association and beam management by executing the function of the above-mentioned balancing unit 402 described with reference to FIG. 1.

### Application Example About User Equipment

### First Application Example

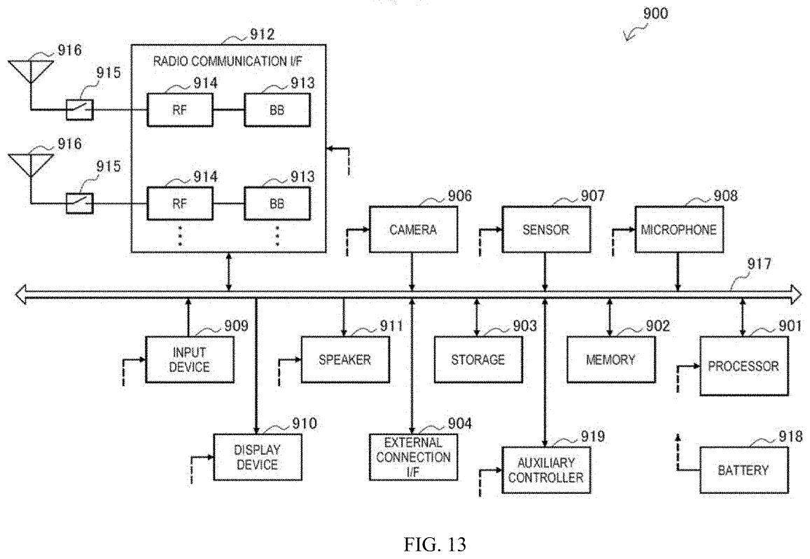

FIG. 13 is a block diagram showing an example of a schematic configuration of a smart phone to which the technology of the present disclosure can be applied. The smart phone 900 includes a processor 901, a memory 902, a storage 903, an external connection interface 904, an camera 906, a sensor 907, a microphone 908, an input device 909, a display device 910, a speaker 911, a radio communication interface 912, one or more antenna switches 915, one or more antennas 916, a bus 917, a battery 918, and an auxiliary controller 919.

The processor 901 may be, for example, a CPU or a system on a chip (SoC), and controls the functions of the application layer and other layers of the smart phone 900. The memory 902 includes an RAM and an ROM, and stores data and programs executed by the processor 901. The storage 903 may include a storage medium such as a semiconductor memory and a hard disk. The external connection interface 904 is an interface for connecting an external device (such as a memory card and a universal serial bus (USB) device) to the smart phone 900.

The camera 906 includes an image sensor (such as a charge coupled device (CCD) and a complementary metal oxide semiconductor (CMOS)), and generates a captured image. The sensor 907 may include a group of sensors, such as a measurement sensor, a gyro sensor, a geomagnetic sensor, and an acceleration sensor. The microphone 908 converts sound input to the smart phone 900 into an audio signal. The input device 909 includes, for example, a touch sensor, a keypad, a keyboard, a button, or a switch configured to detect a touch on a screen of the display device 910, and receives an operation or information input from the user. The display device 910 includes a screen (such as a liquid crystal display (LCD) and an organic light emitting diode (OLED) display), and displays an output image of the smart phone 900. The speaker 911 converts the audio signal output from the smart phone 900 into sound.

The radio communication interface 912 supports any cellular communication scheme (such as LTE and LTE-Advanced), and executes wireless communications. The radio communication interface 912 may generally include, for example, a BB processor 913 and an RF circuit 914. The BB processor 913 may execute, for example, encoding/decoding, modulation/demodulation, and multiplexing/demultiplexing, and execute various types of signal processing for wireless communications. Meanwhile, the RF circuit 914 may include, for example, a mixer, a filter, and an amplifier, and transmit and receive wireless signals via the antenna 916. Note that, although the figure shows a circumstance where one RF link is connected with one antenna, this is only schematic, and a circumstance where one RF link is connected with multiple antennas through multiple phase shifters is also included. The radio communication interface 912 may be a chip module on which the BB processor 913 and the RF circuit 914 are integrated. As shown in FIG. 13, the radio communication interface 912 may include multiple BB processors 913 and multiple RF circuits 914. Although FIG. 13 shows an example in which the radio communication interface 912 includes multiple BB processors 913 and multiple RF circuits 914, the radio communication interface 912 may also include a single BB processor 913 or a single RF circuit 914.

Furthermore, in addition to the cellular communication scheme, the radio communication interface 912 may support other types of wireless communication schemes, such as a short-range wireless communication scheme, a near field communication scheme, and a wireless local area network (LAN) scheme. In this case, the radio communication interface 912 may include a BB processor 913 and an RF circuit 914 for each wireless communication scheme.

Each of the antenna switches 915 switches a connection destination of the antenna 916 among multiple circuits included in the radio communication interface 912 (e.g., circuits for different wireless communication schemes).

Each of the antennas 916 includes a single or multiple antenna elements (such as multiple antenna elements included in a MIMO antenna), and is used for the radio communication interface 912 to transmit and receive wireless signals. As shown in FIG. 13, the smart phone 900 may include multiple antennas 916. Although FIG. 13 shows an example in which the smart phone 900 includes multiple antennas 916, the smart phone 900 may also include a single antenna 916.

Furthermore, the smart phone 900 may include an antenna 916 for each wireless communication scheme. In this case, the antenna switch 915 may be omitted from the configuration of the smart phone 900.

The bus 917 connects the processor 901, the memory 902, the storage 903, the external connection interface 904, the camera 906, the sensor 907, the microphone 908, the input device 909, the display device 910, the speaker 911, the radio communication interface 912, and the auxiliary controller 919 to each other. The battery 918 supplies power to each block of the smart phone 900 as shown in FIG. 13 via a feeder line, which is partially shown as a dashed line in the figure. The auxiliary controller 919 manipulates the least necessary function of the smart phone 900 in a sleep mode, for example.

In the smart phone 900 as shown in FIG. 13, the transceiver of the electronic device 500 may be implemented by the radio communication interface 912. At least a part of the function may also be implemented by the processor 901 or the auxiliary controller 919. For example, the processor 901 or the auxiliary controller 919 may perform user association by executing the function of the above-mentioned processing unit 502 described with reference to FIG. 8.

### Second Application Example

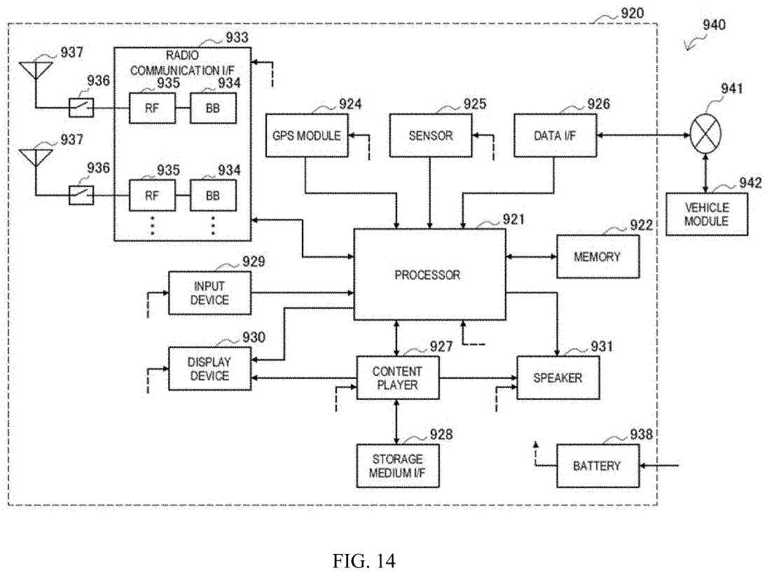

FIG. 14 is a block diagram showing an example of a schematic configuration of automobile navigation equipment to which the technology of the present disclosure can be applied. The automobile navigation equipment 920 includes a processor 921, a memory 922, a global positioning system (GPS) module 924, a sensor 925, a data interface 926, a content player 927, a storage medium interface 928, an input device 929, a display device 930, a speaker 931, a radio communication interface 933, one or more antenna switches 936, one or more antennas 937, and a battery 938.

The processor 921 may be, for example, a CPU or a SoC, and controls the navigation function of the automobile navigation equipment 920 and additional functions. The memory 922 includes an RAM and an ROM, and stores data and programs executed by the processor 921.

The GPS module 924 uses a GPS signal received from a GPS satellite to measure a position of the automobile navigation equipment 920 (such as latitude, longitude, and altitude). The sensor 925 may include a group of sensors, such as a gyro sensor, a geomagnetic sensor, and an air pressure sensor. The data interface 926 is connected to, for example, an in-vehicle network 941 via a terminal not shown, and acquires data (such as vehicle speed data) generated by a vehicle.

The content player 927 reproduces content stored in a storage medium (such as a CD and a DVD), which is inserted into the storage medium interface 928. The input device 929 includes, for example, a touch sensor, a button, or a switch configured to detect a touch on a screen of the display device 930, and receives an operation or information input from the user. The display device 930 includes a screen such as an LCD or OLED display, and displays an image of a navigation function or reproduced content. The speaker 931 outputs the sound of the navigation function or the reproduced content.

The radio communication interface 933 supports any cellular communication scheme, such as LTE and LTE-Advanced, and executes wireless communication. The radio communication interface 933 may generally include, for example, a BB processor 934 and an RF circuit 935. The BB processor 934 may execute, for example, encoding/decoding, modulation/demodulation, and multiplexing/demultiplexing, and execute various types of signal processing for wireless communications. Meanwhile, the RF circuit 935 may include, for example, a mixer, a filter, and an amplifier, and transmit and receive wireless signals via the antenna 937. The radio communication interface 933 may also be a chip module on which the BB processor 934 and the RF circuit 935 are integrated. As shown in FIG. 14, the radio communication interface 933 may include multiple BB processors 934 and multiple RF circuits 935. Although FIG. 14 shows an example in which the radio communication interface 933 includes multiple BB processors 934 and multiple circuits 935, the radio communication interface 933 may also include a single BB processor 934 or a single RF circuit 935.

Furthermore, in addition to the cellular communication scheme, the radio communication interface 933 may support types of wireless communication schemes, such as a short-range wireless communication scheme, a near field communication scheme, and a wireless LAN scheme. In this case, the radio communication interface 933 may include a BB processor 934 and an RF circuit 935 for each wireless communication scheme.

Each of the antenna switches 936 switches a connection destination of the antenna 937 among multiple circuits included in the radio communication interface 933 (e.g., circuits for different wireless communication schemes).

Each of the antennas 937 includes a single or multiple antenna elements (such as multiple antenna elements included in a MIMO antenna), and is used for the radio communication interface 933 to transmit and receive wireless signals. As shown in FIG. 14, the automobile navigation equipment 920 may include multiple antennas 937. Although FIG. 14 shows an example in which the automobile navigation equipment 920 includes multiple antennas 937, the automobile navigation equipment 920 may also include a single antenna 937.

Furthermore, the automobile navigation equipment 920 may include an antenna 937 for each wireless communication scheme. In this case, the antenna switch 936 may be omitted from the configuration of the automobile navigation equipment 920.

The battery 938 supplies power to each block of the automobile navigation equipment 920 as shown in FIG. 14 via a feeder line, which is partially shown as a dashed line in the figure. The battery 938 accumulates electric power supplied from the vehicle.

In the automobile navigation equipment 920 as shown in FIG. 14, the transceiver of the electronic device 500 may be implemented by the radio communication interface 912. At least a part of the function may also be implemented by the processor 901 or the auxiliary controller 919. For example, the processor 901 or the auxiliary controller 919 may perform user association by executing the function of the above-mentioned processing unit 502 described with reference to FIG. 8.

The technology of the present disclosure may also be implemented as an in-vehicle system (or vehicle) 940 including one or more blocks in the automobile navigation equipment 920, the in-vehicle network 941, and the vehicle module 942. The vehicle module 942 generates vehicle data (such as vehicle speed, engine speed, and failure information), and outputs the generated data to the in-vehicle network 941.

The basic principle of the present invention has been described above in conjunction with specific embodiments. However, it should be pointed out that, for those skilled in the art, it could be understood that all or any step or component of the methods and devices of the present invention may be implemented in any computing device (including processors, storage media, etc.) or network of computing devices in the form of hardware, firmware, software, or a combination thereof. This can be achieved by those skilled in the art utilizing their basic circuit design knowledge or basic programming skills after reading the description of the present invention.

Moreover, the present invention also proposes a program product storing a machine-readable instruction code that, when read and executed by a machine, can execute the above-mentioned methods according to the embodiments of the present invention.

Accordingly, a storage medium for carrying the above-mentioned program product storing a machine-readable instruction code is also included in the disclosure of the present invention. The storage medium includes, but is not limited to, a floppy disk, an optical disk, a magneto-optical disk, a memory card, a memory stick, etc.

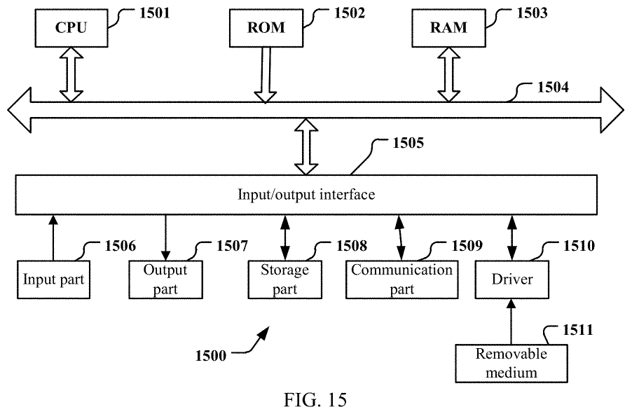

In a case where the present invention is implemented by software or firmware, a program constituting the software is installed from a storage medium or a network to a computer with a dedicated hardware structure (e.g., a general-purpose computer 1500 as shown in FIG. 15), and the computer, when installed with various programs, can execute various functions and the like.

In FIG. 15, a central processing unit (CPU) 1501 executes various processing in accordance with a program stored in a read only memory (ROM) 1502 or a program loaded from a storage part 1508 to a random access memory (RAM) 1503. In the RAM 1503, data required when the CPU 1501 executes various processing and the like is also stored as needed. The CPU 1501, the ROM 1502, and the RAM 1503 are connected to each other via a bus 1504. The input/output interface 1505 is also connected to the bus 1504.

The following components are connected to the input/output interface 1505: an input part 1506 (including a keyboard, a mouse, etc.), an output part 1507 (including a display, such as a cathode ray tube (CRT), a liquid crystal display (LCD), etc., and a speaker, etc.), a storage part 1508 (including a hard disk, etc.), and a communication part 1509 (including a network interface card such as an LAN card, a modem, etc.). The communication part 1509 executes communication processing via a network such as the Internet. The driver 1510 may also be connected to the input/output interface 1505, as needed. A removable medium 1511 such as a magnetic disk, an optical disk, a magneto-optical disk, a semiconductor memory and the like is installed on the driver 1510 as needed, so that a computer program read out therefrom is installed into the storage part 1508 as needed.

In a case where the above-mentioned series of processing is implemented by software, a program constituting the software is installed from a network such as the Internet or a storage medium such as the removable medium 1511.

Those skilled in the art should understand that, this storage medium is not limited to the removable medium 1511 as shown in FIG. 15 which has a program stored therein and which is distributed separately from an apparatus to provide the program to users. Examples of the removable media 1511 include magnetic disks (including a floppy disk (registered trademark)), an optical disk (including a compact disk read-only memory (CD-ROM) and a digital versatile disk (DVD)), a magneto-optical disk (including a mini disk (MD) (registered trademark)), and a semiconductor memory. Alternatively, the storage medium may be the ROM 1502, a hard disk included in the storage part 1508, etc., which have programs stored therein and which are distributed concurrently with the apparatus including them to users.

It should also be pointed out that in the devices, methods and systems of the present invention, each component or each step may be decomposed and/or recombined. These decompositions and/or recombinations should be regarded as equivalent solutions of the present invention. Moreover, the steps of executing the above-mentioned series of processing may naturally be executed in chronological order in the order as described, but do not necessarily need to be executed in chronological order. Some steps may be executed in parallel or independently of each other.

Finally, it should be noted that, the terms “include”, “comprise” or any other variants thereof are intended to cover non-exclusive inclusion, so that a process, method, article or apparatus that includes a series of elements not only includes those elements, but also includes other elements that are not explicitly listed, or but also includes elements inherent to such a process, method, article, or apparatus. Furthermore, in the absence of more restrictions, an element defined by sentence “including one . . . ” does not exclude the existence of other identical elements in a process, method, article, or apparatus that includes the element.

Although the embodiments of the present invention have been described above in detail in conjunction with the accompanying drawings, it should be appreciated that, the above-described embodiments are only used to illustrate the present invention and do not constitute a limitation to the present invention. For those skilled in the art, various modifications and changes may be made to the above-mentioned embodiments without departing from the essence and scope of the present invention. Therefore, the scope of the present invention is defined only by the appended claims and equivalent meanings thereof.

This technology can also be implemented as follows.

Annex 1. An electronic device for wireless communications, comprising:

a processing circuit configured to:

in a case of determining that the electronic device is an overloaded electronic device whose load is greater than a predetermined threshold, perform load balancing based on a first beam power of a first beam received by a first user equipment from each of at least one neighboring electronic device of the overloaded electronic device, to determine whether the overloaded electronic device is to be associated with the first user equipment, wherein the first beam is scanned for initial access of a user equipment.

Annex 2. The electronic device according to Annex 1, wherein

the first user equipment is a user equipment associated with the overloaded electronic device, and

the processing circuit is configured to perform the load balancing further based on a second beam power of a second beam received by a second user equipment associated with each neighboring electronic device from an electronic device that is not associated with the second user equipment among the overloaded electronic device and the at least one neighboring electronic device, wherein the second beam is scanned for initial access of the user equipment.

Annex 3. The electronic device according to Annex 2, wherein the processing circuit is configured to offload at least part of user equipments associated with the overloaded electronic device from the overloaded electronic device based on the first beam power corresponding to the overloaded electronic device and the second beam power corresponding to each neighboring electronic device.

Annex 4. The electronic device according to Annex 3, wherein the first beam power is a weighted mean of a beam receiving power of each first beam, and the second beam power is a weighted mean of a beam receiving power of a second beam corresponding to each neighboring electronic device.

Annex 5. The electronic device according to Annex 3 or 4, wherein the processing circuit is configured to calculate performance of the overloaded electronic device and the at least one neighboring electronic device after offloading the at least part of user equipments from the overloaded electronic device and associating the offloaded user equipments with a selected neighboring electronic device among the at least one neighboring electronic device, to determine the at least part of the user equipments and the selected neighboring electronic device in a case of making the performance improved relative to performance of the overloaded electronic device and the at least one neighboring electronic device before the offloading is performed.

Annex 6. The electronic device according to Annex 5, wherein the processing circuit is configured to continuously perform the offloading, until the performance of the overloaded electronic device and the at least one neighboring electronic device after the offloading is performed is not improved compared with the performance of the overloaded electronic device and the at least one neighboring electronic device before the offloading is performed.

Annex 7. The electronic device according to Annex 5 or 6, wherein the performance comprises a sum rate of the overloaded electronic device and a sum rate of the neighboring electronic device.

Annex 8. The electronic device according to any one of Annexes 5 to 7, wherein the processing circuit is configured to notify the at least part of user equipments of offloading from the overloaded electronic device and provide information about the selected neighboring electronic device to the at least part of user equipments.

Annex 9. The electronic device according to according to any one of Annexes 2 to 8, wherein

the processing circuit is configured to receive from each neighboring electronic device the second beam power reported by the second user equipment associated with the neighboring electronic device to the neighboring electronic device.

Annex 10. The electronic device according to Annex 9, wherein

the processing circuit is configured to notify the at least one neighboring electronic device of performing the load balancing, and

each neighboring electronic device notifies the second user equipment associated with the neighboring electronic device of measuring the second beam power.

Annex 11. The electronic device according to according to Annex 1, wherein

the first user equipment is a user equipment that initiates initial access to the overloaded electronic device, and

the processing circuit is configured to perform the load balancing further based on a third beam power of a third beam received by the first user equipment from the overloaded electronic device, wherein the third beam is scanned for initial access of the user equipment.

Annex 12. The electronic device according to Annex 11, wherein

the processing circuit is configured to determine whether the first user equipment is allowed to access the overloaded electronic device based on the first beam power and the third beam power.

Annex 13. The electronic device according to Annex 12, wherein

the first beam power is a weighted mean of a beam receiving power of each first beam, and the third beam power is a weighted mean of a beam receiving power of each third beam.

Annex 14. The electronic device according to Annex 12 or 13, wherein

the processing circuit is configured to calculate an optimal electronic device to be associated with the first user equipment and an optimal beam of the optimal electronic device based on the first beam power and the third beam power and to, in a case of determining that the overloaded electronic device is not the optimal electronic device, refuse the first user equipment to access the overloaded electronic device and inform the first user equipment of information about the optimal electronic device and the optimal beam.

Annex 15. The electronic device according to any one of Annexes 11 to 14, wherein

the processing circuit is configured to insert in the third beam an identification indicating whether a load of the electronic device is greater than the predetermined threshold.

Annex 16. The electronic device according to any one of Annexes 11 to 15, wherein

the processing circuit is configured to receive information about the first beam power from the first user equipment.

Annex 17. The electronic device according to any one of Annexes 1 to 16, wherein

the processing circuit is configured to interact with each neighboring electronic device for load information.

Annex 18. The electronic device according to any one of Annexes 1 to 17, wherein

wherein the neighboring electronic device comprises an underloaded electronic device whose load is less than or equal to the predetermined threshold.

Annex 19. An electronic device for wireless communications, comprising:

a processing circuit configured to:

in a case where a base station is an overloaded base station whose load is greater than a predetermined threshold, measure a beam power of a beam received from each of at least one neighboring base station of the overloaded base station, for the overloaded base station to perform load balancing, wherein the beam is scanned for initial access of the electronic device.

Annex 20. The electronic device according to Annex 19, wherein

the electronic device is an electronic device associated with the overloaded base station, and

the processing circuit is configured to report information about the beam power to the overloaded base station when receiving a notification of performing the load balancing from the overloaded base station.

Annex 21. The electronic device according to Annex 20, wherein

the processing circuit is configured to be disassociated with the overloaded base station after receiving from the overloaded base station a notification to offload from the overloaded base station.

Annex 22. The electronic device according to Annex 21, wherein

the processing circuit is configured to be associated with a neighboring base station to be accessed that is selected from the at least one neighboring base station after receiving information about the neighboring base station to be accessed from the overloaded base station.

Annex 23. The electronic device according to Annex 19, wherein

the electronic device is an electronic device that initiates initial access to the base station, and

the processing circuit is configured to report information about the beam power to the overloaded base station, in a case of determining that the base station is the overloaded base station based on a message indicating whether a load of the base station is greater than the predetermined threshold.

Annex 24. The electronic device according to Annex 23, wherein

the processing circuit is configured to receive from the overloaded base station a message on whether access to the overloaded base station is allowed.

Annex 25. The electronic device according to Annex 24, wherein

the processing circuit is configured to be associated with a neighboring base station to be accessed that is selected from the at least one neighboring base station after receiving from the overloaded base station a notification of refusing access and information about the neighboring base station to be accessed.

Annex 26. The electronic device according to any one of Annexes 23 to 25, wherein

the processing circuit is configured to receive a message indicating whether the load of the base station is greater than the predetermined threshold from a beam scanned by the base station for initial access.

Annex 27. The electronic device according to any one of Annexes 19 to 26, wherein the beam power is a weighted mean of a beam receiving power corresponding to each beam.

Annex 28. A method for wireless communications, comprising:

in a case of determining that an electronic device is an overloaded electronic device whose load is greater than a predetermined threshold, performing load balancing based on a first beam power of a first beam received by a first user equipment from each of at least one neighboring electronic device of the overloaded electronic device, to determine whether the overloaded electronic device is to be associated with the first user equipment, wherein the first beam is scanned for initial access of the user equipment.

Annex 29. A method for wireless communications, comprising:

in a case where a base station is an overloaded base station whose load is greater than a predetermined threshold, measuring a beam power of a beam received from each of at least one neighboring base station of the overloaded base station, for the overloaded base station to perform load balancing, wherein the beam is scanned for initial access of an electronic device.

Annex 30. A computer-readable storage medium having computer-executable instructions stored thereon, wherein the computer-executable instructions, when being executed, perform the method for wireless communications according to any one of Annexes 28 to 29.

1. An electronic device for wireless communications, comprising:
a processing circuit configured to:
in a case of determining that the electronic device is an overloaded electronic device whose load is greater than a predetermined threshold, perform load balancing based on a first beam power of a first beam received by a first user equipment from each of at least one neighboring electronic device of the overloaded electronic device, to determine whether the overloaded electronic device is to be associated with the first user equipment, wherein the first beam is scanned for initial access of a user equipment.

2. The electronic device according to claim 1, wherein
the first user equipment is a user equipment associated with the overloaded electronic device, and
the processing circuit is configured to perform the load balancing further based on a second beam power of a second beam received by a second user equipment associated with each neighboring electronic device from an electronic device that is not associated with the second user equipment among the overloaded electronic device and the at least one neighboring electronic device, wherein the second beam is scanned for initial access of the user equipment.

3. The electronic device according to claim 2, wherein the processing circuit is configured to offload at least part of user equipments associated with the overloaded electronic device from the overloaded electronic device based on the first beam power corresponding to the overloaded electronic device and the second beam power corresponding to each neighboring electronic device.

4. The electronic device according to claim 3, wherein the first beam power is a weighted mean of a beam receiving power of each first beam, and the second beam power is a weighted mean of a beam receiving power of a second beam corresponding to each neighboring electronic device, and/or
wherein the processing circuit is configured to calculate performance of the overloaded electronic device and the at least one neighboring electronic device after offloading the at least part of user equipments from the overloaded electronic device and associating the offloaded user equipments with a selected neighboring electronic device among the at least one neighboring electronic device, to determine the at least part of the user equipments and the selected neighboring electronic device in a case of making the performance improved relative to performance of the overloaded electronic device and the at least one neighboring electronic device before the offloading is performed.

5. (canceled)

6. The electronic device according to claim 5, wherein the processing circuit is configured to continuously perform the offloading, until the performance of the overloaded electronic device and the at least one neighboring electronic device after the offloading is performed is not improved compared with the performance of the overloaded electronic device and the at least one neighboring electronic device before the offloading is performed.

7. The electronic device according to claim 4, wherein the performance comprises a sum rate of the overloaded electronic device and a sum rate of the neighboring electronic device, and/or
wherein the processing circuit is configured to notify the at least part of user equipments of offloading from the overloaded electronic device and provide information about the selected neighboring electronic device to the at least part of user equipments.

8. (canceled)

9. The electronic device according to claim 2, wherein
the processing circuit is configured to receive from each neighboring electronic device the second beam power reported by the second user equipment associated with the neighboring electronic device to the neighboring electronic device, and
the processing circuit is configured to notify the at least one neighboring electronic device of performing the load balancing, and
each neighboring electronic device notifies the second user equipment associated with the neighboring electronic device of measuring the second beam power.

10. (canceled)

11. The electronic device according to claim 1, wherein
the first user equipment is a user equipment that initiates initial access to the overloaded electronic device, and
the processing circuit is configured to perform the load balancing further based on a third beam power of a third beam received by the first user equipment from the overloaded electronic device, wherein the third beam is scanned for initial access of the user equipment.

12. The electronic device according to claim 11, wherein
the processing circuit is configured to determine whether the first user equipment is allowed to access the overloaded electronic device based on the first beam power and the third beam power.

13. The electronic device according to claim 12, wherein
the first beam power is a weighted mean of a beam receiving power of each first beam, and the third beam power is a weighted mean of a beam receiving power of each third beam, and/or
the processing circuit is configured to calculate an optimal electronic device to be associated with the first user equipment and an optimal beam of the optimal electronic device based on the first beam power and the third beam power and to, in a case of determining that the overloaded electronic device is not the optimal electronic device, refuse the first user equipment to access the overloaded electronic device and inform the first user equipment of information about the optimal electronic device and the optimal beam.

14. (canceled)

15. The electronic device according to claim 8, wherein
the processing circuit is configured to insert in the third beam an identification indicating whether a load of the electronic device is greater than the predetermined threshold, and/or
the processing circuit is configured to receive information about the first beam power from the first user equipment.

16. (canceled)

17. The electronic device according to claim 1, wherein
the processing circuit is configured to interact with each neighboring electronic device for load information, and/or
wherein the neighboring electronic device comprises an underloaded electronic device whose load is less than or equal to the predetermined threshold.

18. (canceled)

19. An electronic device for wireless communications, comprising:
a processing circuit configured to:
in a case where a base station is an overloaded base station whose load is greater than a predetermined threshold, measure a beam power of a beam received from each of at least one neighboring base station of the overloaded base station, for the overloaded base station to perform load balancing, wherein the beam is scanned for initial access of the electronic device.

20. The electronic device according to claim 19, wherein
the electronic device is an electronic device associated with the overloaded base station, and
the processing circuit is configured to report information about the beam power to the overloaded base station when receiving a notification of performing the load balancing from the overloaded base station.

21. The electronic device according to claim 20, wherein
the processing circuit is configured to be disassociated with the overloaded base station after receiving from the overloaded base station a notification to offload from the overloaded base station.

22. The electronic device according to claim 21, wherein
the processing circuit is configured to be associated with a neighboring base station to be accessed that is selected from the at least one neighboring base station after receiving information about the neighboring base station to be accessed from the overloaded base station.

23. The electronic device according to claim 19, wherein
the electronic device is an electronic device that initiates initial access to the base station, and
the processing circuit is configured to report information about the beam power to the overloaded base station, in a case of determining that the base station is the overloaded base station based on a message indicating whether a load of the base station is greater than the predetermined threshold.

24. The electronic device according to claim 23, wherein
the processing circuit is configured to receive from the overloaded base station a message on whether access to the overloaded base station is allowed.

25. The electronic device according to claim 24, wherein
the processing circuit is configured to be associated with a neighboring base station to be accessed that is selected from the at least one neighboring base station after receiving from the overloaded base station a notification of refusing access and information about the neighboring base station to be accessed, and/or
the processing circuit is configured to receive a message indicating whether the load of the base station is greater than the predetermined threshold from a beam scanned by the base station for initial access.

26. (canceled)

27. The electronic device according to claim 13, wherein the beam power is a weighted mean of a beam receiving power corresponding to each beam.

28.-30. (canceled)
